(19) United States
(12) Patent Application Publication
(10) Pub. No.: US 2024/0205914 A1
(43) Pub. Date: Jun. 20, 2024

(54) COMMUNICATION METHOD AND RELATED APPARATUS

(71) Applicant: HUAWEI TECHNOLOGIES CO., LTD., Shenzhen (CN)

(72) Inventors: Ting WANG, Shanghai (CN); Yongxia LYU, Shenzhen (CN); Jun WANG, Shanghai (CN); Liqing ZHANG, Ottawa (CA); Jianglei MA, Ottawa (CA)

(73) Assignee: HUAWEI TECHNOLOGIES CO., LTD., Shenzhen, GD (CN)

(21) Appl. No.: 18/404,060

(22) Filed: Jan. 4, 2024

Related U.S. Application Data
(63) Continuation of application No. PCT/CN2022/104031, filed on Jul. 6, 2022.

(30) Foreign Application Priority Data
Jul. 7, 2021 (CN) 202110769413.6

(51) Int. Cl. H04W 72/1263; H04L 5/00; H04W 72/0446; H04W 72/20

(52) U.S. Cl. CPC H04W 72/1263; H04L 5/0051; H04W 72/0446; H04W 72/20

(57) ABSTRACT

A communication method to reduce a communication latency. The method includes: a terminal obtains a mapping relationship, where the mapping relationship includes a mapping relationship between M parameter sets and M time periods, the parameter set includes a value of at least one parameter, and M is an integer greater than or equal to 2. The terminal receives first control information in a first time period based on the mapping relationship, where the first time period is included in the M time periods.

### CROSS-REFERENCE TO RELATED APPLICATIONS

This application is a continuation of International Application No. PCT/CN2022/104031, filed on Jul. 6, 2022, which claims priority to Chinese Patent Application No.202110769413.6, filed on Jul. 7, 2021. The disclosures of the aforementioned applications are hereby incorporated by reference in their entireties.

### TECHNICAL FIELD

The embodiments relate to a communication method and a related apparatus.

### BACKGROUND

In the industrial manufacturing field, a terminal may need to be managed based on wireless communication.

To perform communication between the terminal and a base station, the terminal and the base station need to perform beam scanning, beam management, beam tracking, and the like, to determine an optimal beam that achieves best communication quality. However, performing the foregoing operations such as the beam scanning, the beam management, and the beam tracking causes a large communication latency and large pilot overheads.

### SUMMARY

The embodiments provide a communication method and a related apparatus, to reduce a communication latency.

A first aspect of the embodiments provides a communication method.

A terminal obtains a mapping relationship, where the mapping relationship includes a mapping relationship between M parameter sets and M time periods, the parameter set includes a value of at least one parameter, and M is an integer greater than or equal to 2. The terminal receives first control information in a first time period based on the mapping relationship, where the first time period is included in the M time periods.

In this embodiment, the terminal may determine, based on the mapping relationship, the parameter sets corresponding to the time periods, to receive the control information based on the corresponding parameter set, and there may be a correspondence between the parameter set and a beam. Therefore, steps such as beam scanning, beam management, and beam tracking do not need to be performed, and the beam is directly determined based on the correspondence, so that a communication latency is reduced.

In a possible implementation, the terminal obtains the mapping relationship by receiving the configuration information, where the configuration information indicates the mapping relationship.

In this embodiment, the terminal may flexibly obtain the mapping relationship, to meet a change of the parameter sets, match service transmission, and improve communication performance.

In a possible implementation, there may be a correspondence between the parameter set and a beam.

In this embodiment, the beam may be a beam that can achieve best communication quality. The terminal also determines the beam corresponding to the time period when determining the parameter set corresponding to the time period, and therefore directly determines the optimal beam without performing beam scanning and beam tracking, so that a communication latency is reduced.

In a possible implementation, the at least one parameter in different parameter sets in the M parameter sets has different values.

In a possible implementation, the parameter in the parameter set includes at least one of control resource set configuration information, a radio network temporary identifier (RNTI), reference signal configuration information, and a control information transmission mode.

In this embodiment, dynamic terminal pairing can be implemented, the control information can be transmitted more flexibly, and the terminal can be dynamically scheduled, so that a beam switching latency is reduced, and communication performance is improved.

In a possible implementation, the control resource set configuration information indicates a time-frequency position corresponding to the first control information, the radio network temporary identifier is used to parse the first control information, the reference signal configuration information indicates a time-frequency position and/or a sequence corresponding to a reference signal, and the control information transmission mode indicates a transmission mode of the first control information.

In a possible implementation, the control resource set configuration information is used to configure a control resource set, the radio network temporary identifier identifies a terminal device, the reference signal configuration information is used to configure a reference signal, and the control information transmission mode indicates a transmission mode of the control information.

In a possible implementation, the time period includes any one of one or more time domain symbols, one or more slots, and one or more subframes.

In a possible implementation, the control information transmission mode includes a first control information transmission mode and a second control information transmission mode, the first control information transmission mode indicates that the first control information includes a plurality of pieces of control subinformation, the plurality of pieces of control subinformation respectively correspond to a plurality of terminals, and the second control information transmission mode indicates that the first control information corresponds to one terminal.

In a possible implementation, the control information transmission mode includes group control information transmission and single control information transmission.

In this embodiment, a transmission mode of the single control information and a transmission mode of the group control information can be dynamically switched based on the time period, so that control information overheads are reduced, and the control information is transmitted based on an actual scheduling status, so that communication performance is improved.

In a possible implementation, the first control information is used for scheduling signal transmission.

In a possible implementation, there is a correspondence between the control resource set configuration information and at least one of the RNTI, the reference signal configuration information, and the control information transmission mode.

In a possible implementation, there is a correspondence between one piece of control resource set configuration information and at least one of at least two RNTIs, at least two pieces of reference signal configuration information, and two control information transmission modes.

In a possible implementation, there is a correspondence between one piece of control resource set configuration information and at least one of one RNTI, one piece of reference signal configuration information, and one control information transmission mode.

In a possible implementation, if the first control information includes the plurality of pieces of control subinformation, there is an association relationship between a position of target control subinformation in the plurality of pieces of control subinformation in the first control information and the value of the at least one parameter.

In a possible implementation, if the first control information includes the plurality of pieces of control subinformation, the position of the target control subinformation in the first control information is determined based on the value of the at least one parameter.

In a possible implementation, the terminal performs channel estimation on the first control information based on a resource granularity of channel estimation, where the resource granularity of the channel estimation is N₁ control channel elements (CCEs) or N₂ resource element groups (REGs), and N₁ and N₂ are integers greater than 0.

In a possible implementation, the terminal receives indication information, where the indication information indicates the resource granularity.

In a possible implementation, there is an association relationship between the time periods and a time periodicity and a time offset; or there is an association relationship between the time periods and a time start position and a time length.

In a possible implementation, the terminal determines the time periods based on the time periodicity and the time offset; or determines the time periods based on the time start position and the time length.

In a possible implementation, there is an association relationship between the mapping relationship and the time periodicity, the time offset, and a time interval; or there is an association relationship between the mapping relationship and the time start position, the time length, and a time interval.

In a possible implementation, the mapping relationship is determined based on the time periodicity, the time offset, and the time interval; or the mapping relationship is determined based on the time start position, the time length, and the time interval.

In a possible implementation, the terminal receives the configuration information, where the configuration information indicates at least one of the time periodicity, the time offset, and the time interval. Alternatively, the terminal receives the configuration information, where the configuration information indicates at least one of the time start position, the time length, and the time interval.

In a possible implementation, there is a correspondence between the time interval and a motion speed of the terminal. Alternatively, the terminal determines the time interval based on a motion speed of the terminal.

A second aspect of the embodiments provides a communication method.

A network device obtains a mapping relationship, where the mapping relationship includes a mapping relationship between M parameter sets and M time periods, the parameter set includes a value of at least one parameter, and M is an integer greater than or equal to 2. The network device sends first control information in a first time period based on the mapping relationship, where the first time period is included in the M time periods.

In this embodiment, the network device sends, to a terminal, the control information corresponding to the parameter set, to reduce a communication latency.

In a possible implementation, the network device sends the configuration information, where the configuration information indicates the mapping relationship.

In this embodiment, the network device may send the obtained mapping relationship by using the configuration information, so that the terminal obtains the mapping relationship, and receives the control information based on the mapping relationship, to meet a change of the parameter sets, match service transmission, and improve communication performance.

In a possible implementation, there may be a correspondence between the parameter set and a beam.

In this embodiment, the beam may be a beam that can achieve best communication quality. The terminal also determines the beam corresponding to the time period when determining the parameter set corresponding to the time period, and therefore directly determines the optimal beam without performing beam scanning and beam tracking, so that a communication latency is reduced.

In a possible implementation, the at least one parameter in different parameter sets in the M parameter sets has different values.

In a possible implementation, the parameter in the parameter set includes at least one of control resource set configuration information, a radio network temporary identifier (RNTI), reference signal configuration information, and a control information transmission mode.

In this embodiment, dynamic terminal pairing is implemented, control information can be transmitted more flexibly, and the terminal can be dynamically scheduled, so that a beam switching latency is reduced, and communication performance is improved.

In a possible implementation, the control resource set configuration information indicates a time-frequency position corresponding to the first control information, the radio network temporary identifier is used to parse the first control information, the reference signal configuration information indicates a time-frequency position and/or a sequence corresponding to a reference signal, and the control information transmission mode indicates a transmission mode of the first control information.

In a possible implementation, the control resource set configuration information is used to configure a control resource set, the radio network temporary identifier identifies a terminal device, the reference signal configuration information is used to configure a reference signal, and the control information transmission mode indicates a transmission mode of the control information.

In a possible implementation, the time period includes any one of one or more time domain symbols, one or more slots, and one or more subframes.

In a possible implementation, the control information transmission mode includes a first control information transmission mode and a second control information transmission mode, the first control information transmission mode indicates that the first control information includes a plurality of pieces of control subinformation, the plurality of pieces of control subinformation respectively correspond to a plurality of terminals, and the second control information transmission mode indicates that the first control information corresponds to one terminal.

In a possible implementation, the control information transmission mode includes group control information transmission and single control information transmission.

In this embodiment, a transmission mode of the single control information and a transmission mode of the group control information are dynamically switched based on the time period, so that control information overheads are reduced, and the control information is transmitted based on an actual scheduling status, so that communication performance is improved.

In a possible implementation, the first control information is used for scheduling signal transmission.

In a possible implementation, there is a correspondence between the control resource set configuration information and at least one of the RNTI, the reference signal configuration information, and the control information transmission mode.

In a possible implementation, there is a correspondence between one piece of control resource set configuration information and at least one of at least two RNTIs, at least two pieces of reference signal configuration information, and two control information transmission modes.

In a possible implementation, there is a correspondence between one piece of control resource set configuration information and at least one of one RNTI, one piece of reference signal configuration information, and one control information transmission mode.

In a possible implementation, if the first control information includes the plurality of pieces of control subinformation, there is an association relationship between a position of target control subinformation in the plurality of pieces of control subinformation in the first control information and the value of the at least one parameter.

In a possible implementation, if the first control information includes the plurality of pieces of control subinformation, the position of the target control subinformation in the first control information is determined based on the value of the at least one parameter.

In a possible implementation, the network device sends indication information, where the indication information indicates a resource granularity of channel estimation. The terminal performs channel estimation on the first control information based on the resource granularity of the channel estimation, where the resource granularity of the channel estimation is N₁ control channel elements (CCEs) or N₂ resource element groups (REGs), and N₁ and N₂ are integers greater than 0.

In a possible implementation, there is an association relationship between the time periods and a time periodicity and a time offset; or there is an association relationship between the time periods and a time start position and a time length.

In a possible implementation, the terminal determines the time periods based on the time periodicity and the time offset; or determines the time periods based on the time start position and the time length.

In a possible implementation, there is an association relationship between the mapping relationship and the time periodicity, the time offset, and a time interval; or there is an association relationship between the mapping relationship and the time start position, the time length, and a time interval.

In a possible implementation, the mapping relationship is determined based on the time periodicity, the time offset, and the time interval; or the mapping relationship is determined based on the time start position, the time length, and the time interval.

In a possible implementation, the network device sends the configuration information, where the configuration information indicates at least one of the time periodicity, the time offset, and the time interval. Alternatively, the network device sends the configuration information, where the configuration information indicates at least one of the time start position, the time length, and the time interval.

A third aspect of the embodiments provides a terminal, to implement the method in any one of the first aspect or the possible implementations. The terminal includes a corresponding unit or module configured to perform the foregoing method. The unit or module included in the terminal can be implemented by software and/or hardware.

A fourth aspect of the embodiments provides a network device, to implement the method in any one of the second aspect or the possible implementations. The network device includes a corresponding unit or module configured to perform the foregoing method. The unit or module included in the network device can be implemented by software and/or hardware.

A fifth aspect of the embodiments provides a terminal, including a processor, where the processor is coupled to a memory, the memory is configured to store instructions, and when the instructions are executed by the processor, an apparatus is enabled to perform the method in the first aspect.

A sixth aspect of the embodiments provides a network device, including a processor, where the processor is coupled to a memory, the memory is configured to store instructions, and when the instructions are executed by the processor, an apparatus is enabled to perform the method in the second aspect.

A seventh aspect of the embodiments provides a non-transitory computer-readable storage medium, where the non-transitory computer-readable storage medium stores a computer program or instructions, and when the computer program or the instructions are executed, a computer is enabled to perform the method in the first aspect or the second aspect.

### BRIEF DESCRIPTION OF DRAWINGS

FIG. 1 is a schematic diagram of a communication system to which a communication method according to an embodiment is applied;

FIG. 2 is a schematic diagram of another communication system to which a communication method according to an embodiment is applied;

FIG. 3 is a schematic diagram of another communication system to which a communication method according to an embodiment is applied;

FIG. 4 is a schematic diagram of a communication method according to an embodiment;

FIG. 5 is a schematic diagram of a communication method according to an embodiment;

FIG. 6 is a schematic flowchart of a communication method according to an embodiment;

FIG. 7a is a schematic diagram of a subframe structure according to an embodiment;

FIG. 7b is a schematic diagram of M time periods according to an embodiment;

FIG. 7c is another schematic diagram of M time periods according to an embodiment;

FIG. 7d is another schematic diagram of M time periods according to an embodiment;

FIG. 7e is another schematic diagram of M time periods according to an embodiment;

FIG. 7f is another schematic diagram of M time periods according to an embodiment;

FIG. 7g is a schematic diagram of a mapping relationship according to an embodiment;

FIG. 7h is another schematic diagram of a mapping relationship according to an embodiment;

FIG. 7i is another schematic diagram of a mapping relationship according to an embodiment;

FIG. 7j is another schematic diagram of a mapping relationship according to an embodiment;

FIG. 7k is another schematic diagram of a mapping relationship according to an embodiment;

FIG. 7l is a schematic diagram of reference signal pattern information according to an embodiment;

FIG. 8a is a schematic diagram of time-frequency resources according to an embodiment;

FIG. 8b is a schematic diagram of target control subinformation according to an embodiment;

FIG. 8c is another schematic diagram of a mapping relationship according to an embodiment;

FIG. 9 is a schematic diagram of processing control information according to an embodiment;

FIG. 10 is a schematic diagram of a structure of a terminal according to an embodiment of this disclosure;

FIG. 11 is a schematic diagram of a structure of a network device according to an embodiment;

FIG. 12 is another schematic diagram of a structure of a terminal according to an embodiment; and

FIG. 13 is another schematic diagram of a structure of a network device according to an embodiment.

### DETAILED DESCRIPTION OF EMBODIMENTS

The following describes the embodiments with reference to the accompanying drawings. It is clear that the described embodiments are merely some rather than all of the embodiments. A person of ordinary skill in the art may understand that, with development of technologies and emergence of new scenarios, the solutions provided in the embodiments are also applicable to similar problems.

In the embodiments and accompanying drawings, the terms “first”, “second”, and so on are intended to distinguish between similar objects but do not necessarily indicate an order or sequence. It should be understood that the data termed in such a way are interchangeable in proper circumstances, so that the embodiments described herein can be implemented in other orders than the order illustrated or described herein. In addition, the terms “include” and “have” and any other variants are intended to cover the non-exclusive inclusion. For example, a process, method, system, product, or device that includes a list of steps or units is not necessarily limited to those expressly listed steps or units but may include other steps or units not expressly listed or inherent to such a process, method, product, or device.

The embodiments provide a communication method and a related apparatus, to reduce a communication latency of a terminal.

The solutions in the embodiments may be applied to various communication systems, for example, a 5th generation (5G) system such as a long term evolution (LTE) system, an LTE frequency division duplex (FDD) system, an LTE time division duplex (TDD) system, and a new radio (NR) system, and a 6th generation (6G) mobile information technology system; or may be applied to a subsequent evolved standard, for example, a future communication system or another communication system. This is not limited.

In addition, the method may be applied to a vehicle-to-everything (V2X) system; may be applied to a 4G and 5G hybrid networking system, or a device-to-device (D2D) communication system, a machine to machine (M2M) communication system, an internet of things (IoT) system, a frequency division duplex (FDD) system, a time division duplex (TDD) system, a satellite communication system, a wireless fidelity (Wi-Fi) system, and another next-generation communication system; or may be applied to a non-3GPP communication system. This is not limited. The communication method provided in the embodiments may be applied to various communication scenarios, for example, may be applied to one or more of the following communication scenarios: enhanced mobile broadband (eMBB), ultra-reliable low latency communication (URLLC), machine type communication (MTC), internet of things (IoT), narrowband internet of things (NB-IoT), customer premise equipment (CPE), augmented reality (AR), virtual reality (VR), massive machine type communications (mMTC), device-to-device (D2D), vehicle-to-everything (V2X), vehicle-to-vehicle (V2V), and the like.

It should be noted that in this embodiment, the IoT may include one or more of the NB-IoT, the MTC, the mMTC, and the like. This is not limited.

The embodiments may be applied to both a homogeneous network scenario and a heterogeneous network scenario, and a transmission point is not limited. The embodiments may be applied to coordinated multipoint transmission between macro base stations, between micro base stations, and between a macro base station and a micro base station, a duplex system, an access backhaul system, a relay system, and the like. The embodiments may be applied to a low-frequency scenario above 6 GHZ, for example, sub-6 GHz, and are also applicable to a high-frequency scenario above 6 GHZ, terahertz, optical communication, and the like.

The terminal in the embodiments may be user equipment, an access terminal, a subscriber unit, a subscriber station, a mobile station, a remote station, a remote terminal, a mobile device, a user terminal, a terminal, a wireless communication device, a user agent, or a user apparatus. The terminal device may alternatively be a palmtop computer, a mobile Internet device (MID), an eMBB terminal, a URLLC terminal, an MTC terminal, an NB-IoT terminal, a CPE terminal, a VR terminal, an AR terminal, a V2X terminal, a wireless terminal in industrial control, a wireless terminal in self-driving, a wireless terminal in remote medicine, a wireless terminal in a smart grid, a wireless terminal in transportation security, a wireless terminal in a smart city, a wireless terminal in a smart home, a sensor, a cellular phone, a cordless phone, a session initiation protocol (SIP) phone, a wireless local loop (WLL) station, a personal digital assistant (PDA), a computing device or another processing device connected to a wireless modem, an in-vehicle terminal, a vehicle having a vehicle-to-vehicle (V2V) capability, an unmanned aerial vehicle (UAV) having a capability of communicating with an unmanned aerial vehicle, a handheld device having a wireless communication function, a wearable device, a terminal device in a 5G network, a terminal device in a future evolved public land mobile network (PLMN), or the like. This is not limited in the embodiments.

In addition, the terminal in the embodiments may further include a sensor such as a smart printer, a train detector, or a gas station. Main functions of the terminal include collecting data, receiving control information and data from a network device, sending an electromagnetic wave, and transmitting data to the network device.

The network device in the embodiments may be a device configured to communicate with a terminal. The network device may be an evolved NodeB (eNodeB) in an LTE system or may be a wireless controller in a cloud radio access network (CRAN) scenario. Alternatively, the network device may be a relay station, an access point, an in-vehicle device, a wearable device, a network device in a 5G network, a network device in a future evolved network, a satellite base station, or the like. This is not limited in the embodiments. The network device may further include, for example, a node in a 6G system of an xNodeB, a device that may implement a base station function in the future, an access node in a Wi-Fi system, a transmission point (TRP), a transmission point (TP), a mobile switching center, and a device that bears a base station function in device-to-device (D2D), vehicle-to-everything (V2X), or machine-to-machine (M2M) communication. This is not limited herein. Alternatively, the network device may be a device that supports wired access or may be a device that supports wireless access. For example, the network device may be an access network (AN) or a radio access network (RAN) device and includes a plurality of AN or RAN nodes. The AN or RAN node may be a transmission reception point (TRP), an evolved NodeB (eNB), a radio network controller (radio network controller, RNC), a home base station (for example, a home evolved NodeB, or a home NodeB, HNB), a wireless fidelity (Wi-Fi) access point (AP), a radio relay node, a wireless backhaul node, a transmission point (TP) or a transmission reception point (TRP), or the like; or may be an ngNB, a TRP, or a TP in a 5G system, for example, an NR system; or may be one antenna panel or a group of antenna panels of a base station in a 5G system. Alternatively, the network device may alternatively be a network node that forms a next generation base station (NR NodeB, gNB) or a transmission point, for example, a baseband unit (BBU), a distributed unit (DU), or a device that bears a base station function in D2D, V2X, or machine-to-machine (M2M) communication. Alternatively, the network device may be a base station in a future communication system, or another access node. It should be understood that the network device in the embodiments may be any one of the foregoing devices or a chip in the foregoing devices. This is not limited herein. Regardless of serving as a device or a chip, the network device may be manufactured, sold, or used as an independent product. In this embodiment and subsequent embodiments, only a network device is used as an example for description.

The communication method shown in the embodiments may be applied to communication between a first communication apparatus and a second communication apparatus. The first communication apparatus may be a terminal or a network device. The second communication apparatus may be a terminal or a network device. In the following embodiments, an example in which the first communication apparatus is the terminal and the second communication apparatus is the network device is used for description. It should be noted that the communication method shown in the embodiments may be applied to communication between the terminal and the network device, or may be applied to communication between the terminals, or may be applied to communication between the network devices. The communication between the network devices may be coordinated multipoint transmission between macro base stations, between micro base stations, and between a macro base station and a micro base station.

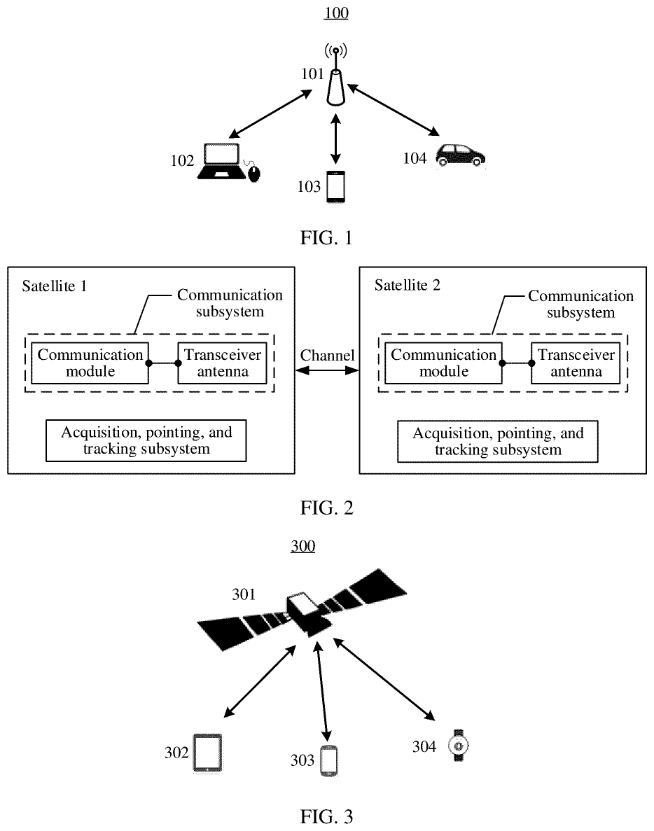

FIG. 1 is a schematic diagram of a communication system to which an embodiment is applicable. FIG. 1 shows a cellular communication system 100, including a network device 101, a terminal device 102, a terminal device 103, and a terminal device 104. Information may be sent between the network device and the terminal device through a channel, and different channels may carry same or different types of information. The network device may send control information to the terminal device through a control channel, to schedule the terminal device. For example, the network device 101 is the network device in the foregoing possible implementation, and the terminal device 102, the terminal device 103, and the terminal device 104 are the terminals in the foregoing possible implementation.

FIG. 2 is another schematic diagram of a communication system to which an embodiment is applicable. FIG. 2 shows an inter-satellite link communication system 200 to which an embodiment is applied. The inter-satellite link communication system includes a satellite 1 and a satellite 2, and the two exchange information through a channel, that is, perform communication between the satellites. The satellite may be used as a network device or may be used as a terminal. The communication system includes a communication subsystem and an acquisition, pointing, and tracking (APT) subsystem. The communication subsystem includes a communication module and a transceiver antenna, is responsible for transmission of inter-satellite information, and is a main body of the inter-satellite communication system. The APT subsystem is responsible for acquisition, alignment, and tracking between the satellites. The acquisition is to determine a direction of arrival of an incident signal, the alignment is to adjust a transmit wave to aim at a receiving direction, and the tracking is to continuously adjust the alignment and acquisition in a communication process. To minimize impact of fading and interference on the channel, and also require high confidentiality and transmission rate, APT needs to be adjusted in real time to adapt to this change.

FIG. 3 is another schematic diagram of a communication system to which an embodiment is applicable. FIG. 3 shows a satellite communication system 300 to which an embodiment is applied. The satellite communication system includes a satellite base station 301, a terminal-type network element 302, a terminal-type network element 303, and a terminal-type network element 304. The satellite base station provides a communication service for the terminal-type network element, and the terminal-type network element may be the terminal device in the foregoing various possible implementations. The satellite base station transmits downlink data to a terminal, where the data is coded through channel coding, and the data obtained after the channel coding is transmitted to the terminal after constellation modulation. The terminal transmits uplink data to the satellite base station, where the uplink data may also be coded through channel coding, and the data obtained after the coding is transmitted to the satellite base station after the constellation modulation.

It should be noted that the wireless communication system includes but is not limited to: a narrowband internet of things (NB-IoT) system, a global system for mobile communication (GSM), an enhanced data rates for GSM evolution (EDGE) system, a wideband code division multiple access (WCDMA) system, a code division multiple access 2000 (CDMA2000) system, a time division-synchronous code division multiple access (TD-SCDMA) system, a long term evolution (LTE) system, and an enhanced mobile broadband (eMBB), URLLC, and internet of things technology (LTE enhanced MTO, eMTC) based on LTE evolution.

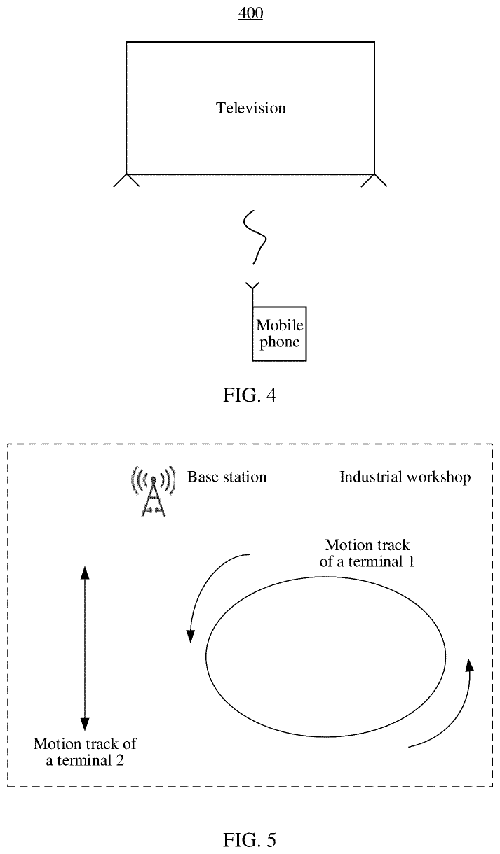

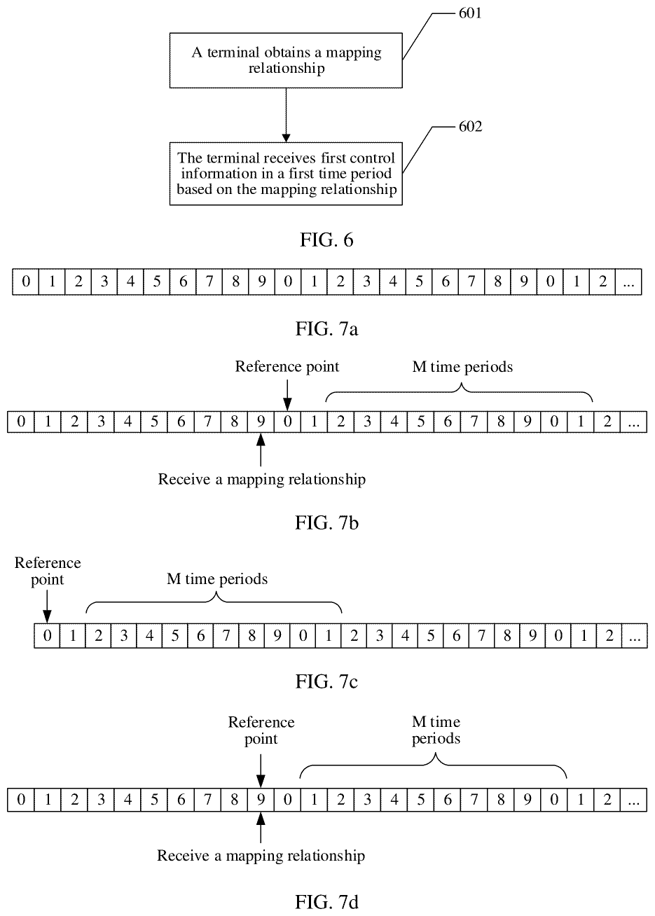

FIG. 4 is another schematic diagram of a communication system to which an embodiment is applicable. FIG. 4 shows a communication system 400 used in a wireless projection scenario according to an embodiment. The communication system includes a television and a mobile phone, and the television and the mobile phone exchange information. In addition, the embodiments may be further applied to a plurality of scenarios such as data encoding and decoding in a virtual reality (VR) game and a mobile phone application (APP). It should be understood that in the foregoing application scenario, the television, the mobile phone, and the like may be used to perform corresponding functions of the network device in the embodiments, or may be configured to perform corresponding functions of the terminal device in the embodiments. This is not limited in the embodiments.

The embodiments may be further applied to URLLC. URLLC is widely applied in fields such as self-driving, industrial manufacturing, internet of vehicles, and a smart grid. The industrial manufacturing field is used as an example. Terminals in a factory may be some devices used for production and manufacturing and may be controlled through a wireless network. Because a production and manufacturing operation in the factory has a high requirement on precision, a communication latency and stability are also required.

In an industrial workshop, a terminal may need to perform periodic motion. For example, a terminal 1 performs periodic elliptic motion in the workshop, and a terminal 2 performs periodic reciprocating motion in the workshop. A relative position of the terminal relative to a base station changes in a motion process. Therefore, a beam that can achieve best communication quality also changes accordingly.

Based on the foregoing communication system, the embodiments provide a communication method. The following explains and describes some nouns or terms used in the embodiments. The nouns or terms and content of related explanations and descriptions thereof are also used as a part of content.

### 1. Physical Downlink Control Channel (PDCCH) and Physical Reception Link Control Channel (PRXCH)

The PDCCH may be used to carry downlink control information (DCI), and carry control information related to data transmission, such as resource allocation information for data transmission, format information of an uplink resource or a downlink resource within a slot, and power control information of an uplink data channel and a downlink data channel and a signal.

In LTE, a time domain resource of the PDCCH is located in first one to three symbols of each slot, and a symbol length is indicated by a physical control format indicator channel (PCFICH). In 5G NR, because a system bandwidth is larger, a more flexible PDCCH resource allocation solution is required. A time-frequency domain resource position occupied by the PDCCH is defined as a control resource set (CORESET), and the CORESET may be configured in a manner such as higher layer signaling.

A control channel element (CCE) is a basic unit of the PDCCH. One CCE occupies N resource element groups (REGs) in time-frequency domain. One REG corresponds to one OFDM symbol in time domain and one resource block (RB) in frequency domain and includes 12 consecutive resource elements (REs). One determined PDCCH may include one, two, four, eight, or 16 CCEs, and a value is determined by a DCI payload size and a required coding rate. A quantity of CCEs included in the PDCCH is referred to as an aggregation level (AL). The base station may select an appropriate aggregation level based on a channel status. When the channel status is poor, the aggregation level is high.

In a possible implementation, a physical control channel PRxCCH may be introduced. The PRxCCH has a function similar to that of the PDCCH in LTE and 5G and may be a channel used to transmit control information. The control information is used to schedule the data transmission. It should be understood that a standard protocol is described from a perspective of a terminal device. Therefore, the physical downlink control channel may be described as the physical reception link control channel.

### 2. Physical Downlink Shared Channel (PDSCH) and Physical Reception Link Shared Channel (PRxSCH)

The PDSCH is a physical channel that carries downlink service data.

A PDSCH sending procedure may include scrambling, modulation, layer mapping, antenna port mapping, virtual resource block mapping, physical resource block mapping, and the like.

In a possible implementation, a physical data channel PRxSCH may be introduced. The PRxSCH has a function similar to that of the PDSCH in LTE and 5G. The channel may be a channel used by a terminal device to receive data, and/or a channel used by a network device to transmit data. It should be understood that, a standard protocol is described from a perspective of the terminal device. Therefore, the physical downlink data channel may be described as a physical reception link data channel.

### 3. Physical Uplink Control Channel (PUCCH) and Physical Transmission Link Control Channel PTxCCH

The physical uplink control channel (PUCCH) may be used to carry uplink control information (UCI). Information used by a terminal device to apply to a network device for uplink resource configuration, information about replying whether downlink service data is correctly received by the terminal device, and channel state information (CSI) of a downlink channel reported by the terminal device may be included.

In a possible implementation, a physical control channel, such as the physical transmission link control channel (PTxCCH), may be introduced. The PTxCCH has a function similar to that of the PUCCH in LTE and 5G. The channel may be a channel used by the terminal device to transmit control information, and/or a channel used by the network device to receive control information. The control information may include at least one of the following: a hybrid automatic repeat request (HARQ), acknowledgment/negative acknowledgment (ACK/NACK) information, channel state information, a scheduling request, and the like. It should be understood that a standard protocol may be described from a perspective of the terminal device. Therefore, the physical uplink control channel may be described as the physical transmission link control channel.

### 4. Physical Uplink Shared Channel PUSCH and Physical Transmission Link Shared Channel PTxSCH

The physical uplink shared channel (PUSCH) is used to transmit uplink service data. The PUSCH may be dynamically scheduled by using DCI or may be configured by using a higher layer parameter to perform scheduling-free transmission or may be semi-persistently scheduled by using DCI after a higher layer parameter is configured.

A sending procedure of the PUSCH may include processes such as scrambling, modulation, layer mapping, transform precoding, precoding, resource mapping, and symbol generation.

In a possible implementation, a physical data channel, such as the physical transmission link shared channel (PTxSCH), may be introduced. The PTxSCH has a function similar to that of the PUSCH in LTE and 5G. The channel may be a channel used by a terminal device to transmit data, and/or a channel used by a network device to receive data. It should be understood that a standard protocol is described from a perspective of the terminal device. Therefore, a physical uplink data channel may be described as a physical transmission link data channel.

### 5. Downlink Control Information (DCI)

The downlink control information (DCI) is transmitted on the PDCCH and is related to a PDSCH and a PUSCH. A terminal device can correctly process PDSCH data or PUSCH data only when correctly decoding the DCI information.

6. A terminal Device Performs Blind Detection.

The terminal device does not know in advance which format of DCI is carried on a to-be-received PDCCH and does not know which candidate PDCCH is used to transmit the DCI either. Therefore, the terminal device needs to perform PDCCH blind detection to receive corresponding DCI. Before successfully decoding the PDCCH, the terminal device may attempt to decode the PDCCH on each possible candidate PDCCH until the terminal device successfully detects the PDCCH, or a quantity of pieces of DCI that the terminal device expects to receive is reached or a quantity of times of blind detection performed by the terminal device is reached.

Alternatively, in other words, the DCI has a plurality of different formats. When receiving the PDCCH, the terminal device cannot determine which format of DCI to which the received DCI belongs, and consequently cannot correctly process data transmitted on a channel such as a PDSCH or a PUSCH. Therefore, the terminal device needs to perform blind detection on the format of the DCI. The terminal device may not know a current format of the DCI and does not know a position of information required by the terminal device either. However, the terminal device knows information in a format expected by the terminal device, and expected information in different formats corresponds to different expected RNTIs and CCEs. Therefore, the terminal device may perform CRC check on the received DCI by using the expected RNTIs and CCEs, to know whether the received DCI is required by the terminal device, and also know a corresponding DCI format and modulation scheme, to further receive the DCI. The foregoing procedure is a blind detection process of the terminal device.

It should be understood that, a cyclic redundancy check (CRC) bit may be added to an information bit of the DCI to implement an error detection function of the terminal device, and scrambling is performed in the CRC bit by using different types of radio network temporary identifiers (RNTIs), so that the RNTI is implicitly encoded in the CRC bit. It should be further understood that different RNTIs can identify the terminal device and also distinguish between purposes of the DCI.

In addition, for the blind detection process of the terminal device, because the PDCCH includes a plurality of CCEs, or the DCI is carried on the plurality of CCEs, the terminal device needs to perform blind detection on the plurality of CCEs. However, if the terminal device performs blind detection one by one at a granularity of the CCEs, efficiency is low. Therefore, a search space is specified in a protocol. The search space may be simply understood as follows: When performing blind detection on a PDCCH, the terminal device performs blind detection at a granularity of several CCEs. For example, if a value of an aggregation level AL that is of a CCE and that is defined in the search space is 4 or 8, when the terminal device performs blind detection, the terminal device first performs blind detection once at a granularity of four CCEs, and then performs blind detection once at a granularity of eight CCEs.

When the value of the AL that is of the CCE and that is defined in the search space is 4 or 8, in addition to the AL 4 or 8, the network device further uses a position index (CCE index) parameter of the CCE when identifying a PDCCH. The position index of the CCE is obtained through calculation based on time-frequency domain information of the PDCCH, the aggregation level, and the like. The terminal device cannot accurately know the aggregation level of the CCE occupied by the PDCCH and a start position index of the CCE. However, before receiving the PDCCH, the terminal device receives higher layer signaling, where the higher layer signaling indicates the time-frequency domain information of the PDCCH and the like. In addition, for example, the terminal device determines, according to a protocol or based on an indication of the network device, that the aggregation level of the PDCCH may be 4 or may be 8. Therefore, when performing blind detection, the terminal device may first calculate the position index of the CCE in the PDCCH based on the time-frequency domain information of the PDCCH and by using the aggregation level 4, where the position index includes the start position index of the CCE; and perform blind detection on the corresponding CCE. Then, when no expected DCI is detected or an expected quantity of pieces of detected DCI is not reached, the terminal device may calculate, based on the time-frequency domain information of the PDCCH and by using the aggregation level 8, the start position index of the CCE in the PDCCH, that is, the position index of the CCE, and perform blind detection on the corresponding CCE.

The following describes the communication method in the embodiments by using an example in which a first communication apparatus is a terminal and a second communication apparatus is a base station.

The following describes a procedure of a communication method according to an embodiment.

601: A terminal obtains a mapping relationship.

Because the terminal moves periodically, and a motion track may also be predicted, a beam that corresponds to the terminal at each position and that can achieve best communication quality, and a parameter corresponding to the terminal that is at each position and that is configured to receive control information may be determined. The control information is used to schedule transmission of a communication signal between a base station and the terminal. After the beam and the parameter are determined, a mapping relationship may be obtained. The mapping relationship indicates a correspondence between the beam and the parameter and time.

In addition, the motion track of the terminal may be obtained by using positioning information, perception, artificial intelligence (AI), a neural network technology, or the like. The correspondence between the beam and the parameter and the time may be determined based on the motion track of the terminal.

The mapping relationship may be obtained via the base station. For example, the base station sends, to the terminal, signaling indicating the mapping relationship, or the mapping relationship is pre-stored on a terminal side, or may be obtained in another manner. For example, the terminal determines the mapping relationship based on the AI. This is not limited herein.

The mapping relationship includes a mapping relationship between M parameter sets and M time periods, where each parameter set includes a value of at least one parameter, and M is an integer greater than or equal to 2.

The time period may include any one of one or more time domain symbols, one or more slots, and one or more subframes. For example, a time period may be two subframes, two milliseconds (ms), or the like.

The M time periods may be Q1 radio frames, Q2 subframes, Q3 time domain symbols, or Q4 milliseconds. Q1, Q2, Q3, and Q4 are positive integers.

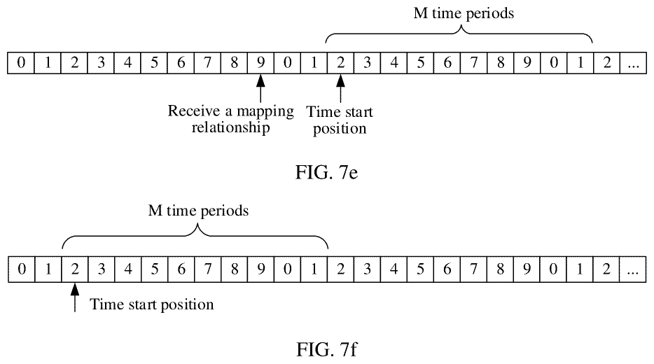

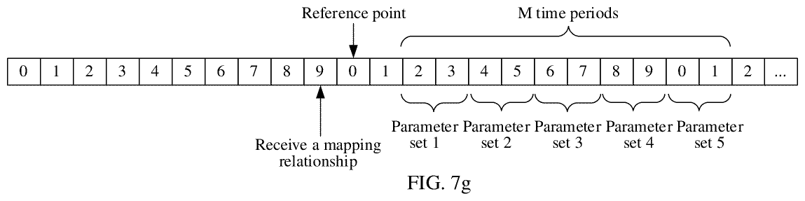

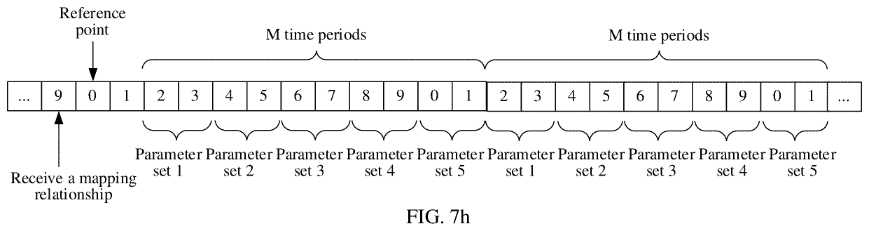

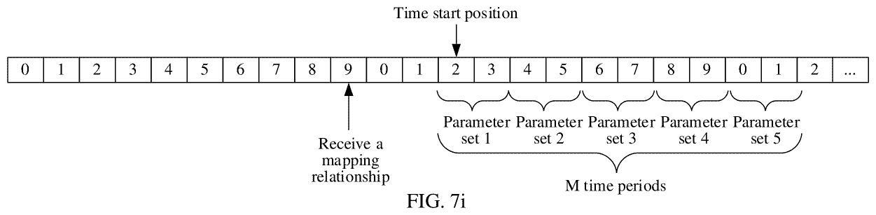

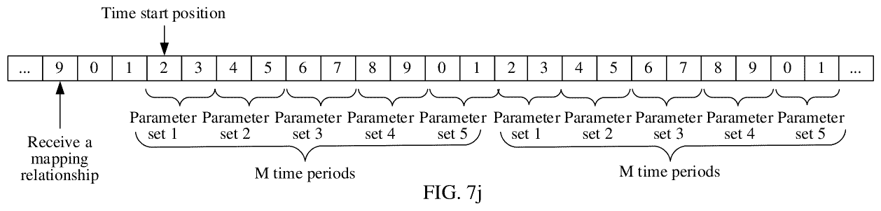

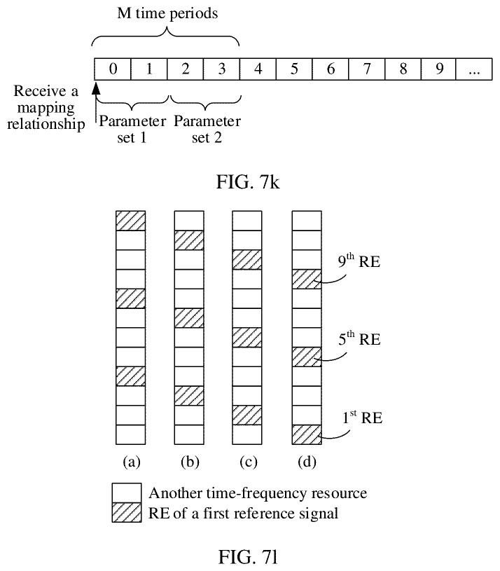

As shown in FIG. 7a, communication between the terminal and the base station is performed in a plurality of subframes. Each subframe may correspond to a number. For example, if the terminal receives a synchronization signal from the base station in the 1st leftmost subframe in FIG. 7a, and the subframe may be numbered 0, subframes after the subframe are numbered 1, 2, 3, 4, 5, 6, 7, 8, and 9. The subframes may alternatively be numbered periodically. A next subframe of the subframe numbered 9 may be numbered 0 and subsequent subframes may be numbered according to the foregoing numbering rule.

Optionally, the M time periods include a first time period and a second time period, values of parameters in a parameter set include a first value and a second value, and that the terminal obtains a correspondence between the parameters and the time periods includes: the first time period corresponds to the first value, and the second time period corresponds to the second value.

Optionally, the first value is different from the second value.

The following provides a method for determining a time period by at least one of the terminal and the base station. The at least one of the terminal and the base station may determine the time period according to at least one of the following methods.

Optionally, the M time periods may be determined based on a time periodicity and a time offset. In other words, there is an association relationship between the M time periods and the time periodicity and the time offset. The time periodicity indicates total duration of the M time periods, and the time offset indicates offsets between the M time periods and a reference point.

Optionally, the base station may send configuration information including at least one of the time periodicity and the time offset. The terminal may receive the configuration information that is sent by the network device and that includes the at least one of the time periodicity and the time offset, and the terminal determines the at least one of the time periodicity and the time offset based on the configuration information.

The reference point may be a subframe with any number. The following provides descriptions by using a subframe 0 as the reference point.

If the mapping relationship is received by the terminal, refer to FIG. 7b. If the terminal receives a mapping relationship from the base station in the 1st subframe 9, the reference point is a next subframe 0 of the subframe in which the mapping relationship is received. If a time offset is two subframes, and a subframe after the two subframes at the reference point is a subframe 2, the subframe 2 is a start position of M time periods, where the start position indicates that the terminal receives control information based on the mapping relationship from the subframe. If a periodicity of the M time periods is 10 subframes, the M time periods include the subframe 2 to a next subframe 1, that is, 10 subframes.

Optionally, the base station may send configuration information of the reference point. The terminal determines the reference point based on the configuration information.

Alternatively, refer to FIG. 7c. If the mapping relationship is pre-stored in the terminal, the reference point is the 1st subframe 0. If the time offset is two subframes, and a subframe after the two subframes at the reference point is the 1st subframe 2, the subframe 2 is a start position of the M time periods. If a periodicity of the M time periods is 10 subframes, the M time periods include the subframe 2 to a next subframe 1, that is, 10 subframes.

In another implementation, the reference point may alternatively be a subframe in which the terminal receives the mapping relationship. If the terminal receives the mapping relationship from the base station in the 1st subframe 9, the reference point is the subframe 9 in which the mapping relationship is received. If the time offset is two subframes, and a subframe after the two subframes at the reference point is a subframe 1, the subframe 1 is a start position of M time periods.

Optionally, the M time periods may alternatively be determined based on a time start position and a time length. In other words, there is an association relationship between the M time periods and the time start position and the time length. The time start position indicates a start position of the M time periods, and the time length indicates total duration of the M time periods.

Optionally, the base station may send configuration information including at least one of the time start position and the time length. The terminal may receive the configuration information that is sent by the network device and that includes at least one of the time start position and the time length and determine the at least one of the start position and the time length based on the configuration information.

The time start position may be a subframe with any number. The following provides descriptions by using a subframe 2 as the time start position.

If the mapping relationship is received by the terminal, refer to FIG. 7e. If the terminal receives a mapping relationship from the base station in the 1st subframe 9, the time start position is a next subframe 2 of the subframe in which the mapping relationship is received. That is, the subframe 2 is a start position of the M time periods. If a periodicity of the M time periods is 10 subframes, the M time periods include the subframe 2 to a next subframe 1, that is, 10 subframes.

Alternatively, this may be shown in FIG. 7f. If the mapping relationship is pre-stored in the terminal, the time start position is the 1st subframe 2. The subframe 2 is a start position of the M time periods. If a periodicity of the M time periods is 10 subframes, the M time periods include the subframe 2 to a next subframe 1, that is, 10 subframes.

The following provides a method for determining a mapping relationship by at least one of the terminal and the base station. The at least one of the terminal and the base station may determine the mapping relationship according to at least one of the following methods.

Optionally, the mapping relationship may be determined by using a time offset, a time periodicity, and a change interval. In other words, there is an association relationship between the mapping relationship and the time offset, the time periodicity, and the change interval. The change interval may also be referred to as a time interval and indicates duration or effective time of the parameter set. The time interval may include any one of one or more time domain symbols, one or more slots, and one or more subframes. For example, a time interval may be two subframes, two milliseconds (ms), or the like.

Optionally, the base station may send configuration information of the time interval. The terminal determines the time interval based on the configuration information.

Optionally, the time interval may be predefined in a protocol, for example, two subframes or one subframe.

Optionally, the terminal receives the configuration information, where the configuration information indicates at least one of the time periodicity, the time offset, and the time interval.

Optionally, the network device sends the configuration information, where the configuration information indicates the at least one of the time periodicity, the time offset, and the time interval.

Optionally, there is a correspondence between the time interval and a motion speed of the terminal. Alternatively, the terminal determines the time interval based on a motion speed of the terminal.

For example, when the motion speed of the terminal is in an interval 1, a corresponding time interval is a time interval T1; when the motion speed of the terminal is in an interval 2, a corresponding time interval is a time interval T2; when the motion speed of the terminal is in an interval 3, a corresponding time interval is a time interval T3; or another case may be used. Details are not described herein again.

When the change interval is P time units, in other words, the time interval is P time units, it indicates that every P time units starting from the 1st time period of the M time periods correspond to one parameter set. The time unit may be any one of a subframe, a slot, a time domain symbol, 1 millisecond, 1 second, or 1 microsecond, or may be another case. This is not limited herein.

Based on the embodiment shown in FIG. 7b, see FIG. 7g. For example, when the change interval is two subframes, a subframe 2 and a subframe 3 correspond to a parameter set 1. Then, a subframe 4 and a subframe 5 correspond to a parameter set 2, a subframe 6 and a subframe 7 correspond to a parameter set 3, a subframe 8 and a subframe 9 correspond to a parameter set 4, and a subframe 0 and a subframe 1 correspond to a parameter set 5.

It may be understood that based on FIG. 7g, see FIG. 7h. A mapping relationship between time periods and the parameter sets may be periodic. That is, after the M time periods end, other M time periods start. On this basis, because the change interval and a time periodicity are unchanged, the terminal may determine a correspondence between the subframes and the parameter set according to a periodicity rule of the mapping relationship, to receive first control information based on the mapping relationship in a subframe in which the mapping relationship is obtained. FIG. 7h is used as an example. The terminal may determine, according to a rule, that a subframe 9 in which the mapping relationship is received corresponds to a parameter set 4, and a subsequent subframe 0 and subframe 1 correspond to a parameter set 5, so that the terminal may receive first control information based on the parameter set 4 in the subframe 9 in which the mapping relationship is received.

Alternatively, the mapping relationship may be determined by using a time start position, a time length, and a change interval. In other words, alternatively, there is an association relationship between the mapping relationship and the time start position, the time length, and the change interval. The change interval may also be referred to as a time interval and indicates duration or effective time of the parameter set. The time interval may include any one of one or more time domain symbols, one or more slots, and one or more subframes. For example, a time interval may be two subframes, two milliseconds (ms), or the like.

Optionally, the base station may send configuration information of the time interval. The terminal determines the time interval based on the configuration information.

Optionally, the time interval may be predefined in a protocol, for example, two subframes or one subframe.

Optionally, the terminal receives the configuration information, where the configuration information indicates at least one of the time start position, the time length, and the time interval.

Optionally, the network device sends the configuration information, where the configuration information indicates the at least one of the time start position, the time length, and the time interval.

When the change interval is P time units, in other words, the time interval is P time units, it indicates that every P time units starting from the 1st time period of the M time periods correspond to one parameter set. The time unit may be any one of a subframe, a slot, a time domain symbol, 1 millisecond, 1 second, or 1 microsecond, or may be another case. This is not limited herein.

Optionally, there is a correspondence between the time interval and a motion speed of the terminal. Alternatively, the terminal determines the time interval based on a motion speed of the terminal.

For example, when the motion speed of the terminal is in an interval 1, a corresponding time interval is a time interval T1; when the motion speed of the terminal is in an interval 2, a corresponding time interval is a time interval T2; when the motion speed of the terminal is in an interval 3, a corresponding time interval is a time interval T3; or another case may be used. Details are not described herein again.

Based on the embodiment shown in FIG. 7e, see FIG. 7i. For example, when the change interval is two subframes, a subframe 2 and a subframe 3 correspond to a parameter set 1. Then, a subframe 4 and a subframe 5 correspond to a parameter set 2, a subframe 6 and a subframe 7 correspond to a parameter set 3, a subframe 8 and a subframe 9 correspond to a parameter set 4, and a subframe 0 and a subframe 1 correspond to a parameter set 5.

This may be shown by FIG. 7i or FIG. 7j. A mapping relationship between time periods and the parameter sets may be periodic. That is, after the M time periods end, other M time periods start. On this basis, because the time length and the change interval are unchanged, the terminal may determine a correspondence between the subframes and the parameter set according to a periodicity rule of the mapping relationship, to receive first control information based on the mapping relationship in a subframe in which the mapping relationship is obtained. FIG. 7j is used as an example. The terminal may determine, according to a rule, that a subframe 9 in which the mapping relationship is received corresponds to a parameter set 4, and a subsequent subframe 0 and subframe 1 correspond to a parameter set 5, so that the terminal may receive first control information based on the parameter set 4 in the subframe 9 in which the mapping relationship is received.

The foregoing describes a case in which the time periodicity is 10 subframes, the change interval is two subframes, and the time offset is two subframes. For ease of further understanding of this solution, the following describes a case in which the time periodicity is four subframes, the change interval is four subframes, and the time offset is 0 subframes.

For example, if the terminal receives a mapping relationship in the 1st subframe 0, and a reference point is also the subframe 0, M time periods include the subframe 0 in which the mapping relationship is received to a next subframe 3, the subframe 0 and a subframe 1 correspond to a parameter set 1, and a subframe 2 and the subframe 3 correspond to a parameter set 2.

It may be understood that in actual implementation, in the embodiments shown in FIG. 7a to FIG. 7k, more subframes may alternatively be included. For brevity of description, details are not described again.

The foregoing separately describes a manner of determining the M time periods and a manner of determining the mapping relationship. The following describes the parameter set in this embodiment.

In this embodiment, the parameter in the parameter set may include at least one of control resource set configuration information, an RNTI, reference signal configuration information, and a control information transmission mode.

The control resource set configuration information is used to configure a control resource set, in other words, indicates a time-frequency position corresponding to the control information.

Different control resource set configuration information may indicate time-frequency resources corresponding to different time-frequency positions. For example, control resource set configuration information 1 indicates a time-frequency resource at a time-frequency position 1, control resource set configuration information 2 indicates a time-frequency resource at a time-frequency position 2, control resource set configuration information 3 indicates a time-frequency resource at a time-frequency position 3, control resource set configuration information 4 indicates a time-frequency resource at a time-frequency position 4, and control resource set configuration information 5 indicates a time-frequency resource at a time-frequency position 5. The base station may send control information based on a time-frequency resource at a time-frequency position, for example, may send control information based on the time-frequency resource at the time-frequency position 1. In this case, the terminal may receive the control information at the time-frequency position 1 based on the time-frequency position 1 indicated by the control resource set configuration information 1.

For example, at a time-frequency position indicated by one piece of control resource set configuration information, a plurality of control channel elements (CCEs) are included, and the plurality of CCEs may be divided into different CCE groups, where the different CCE groups may respectively correspond to different beams or precoding matrices.

For example, at a time-frequency position indicated by one piece of control resource set configuration information, a plurality of REG are included. The plurality of REGs may be divided into different REG groups, and the different REG groups may respectively correspond to different beams or precoding matrices.

For example, when a channel is flat, the CCE groups may correspond to a plurality of discrete resource blocks (RBs) in a bandwidth and correspond to one precoding matrix indicator (PMI). If the channel is not flat, the CCE groups may correspond to consecutive RBs, and correspond to one PMI.

An RNTI identifies a terminal device. The RNTI may be used by the terminal to parse first control information. For example, a CRC bit of the control information is scrambled by using the RNTI.

Reference signal configuration information is used to configure a reference signal. The reference signal configuration information may indicate a time-frequency position or a sequence corresponding to the reference signal, or the reference signal configuration information may indicate a time-frequency position and a sequence corresponding to the reference signal.

The control information transmission mode indicates a transmission mode of the first control information.

It should be noted that a value of the foregoing parameter may correspond to one or more terminals. For example, in a same time period, values of parameters of different terminals may be the same or may be different. This is not limited herein.

The control information transmission mode includes a first control information transmission mode and a second control information transmission mode, that is, includes single control information transmission and group control information transmission. The first control information transmission mode, that is, the group control information transmission, indicates that the first control information includes a plurality of pieces of control subinformation. The first control information includes control subinformation 1, control subinformation 2, control subinformation 3, control subinformation 4, and control subinformation 5, where the control subinformation 1 corresponds to a terminal 2, the control subinformation 2 corresponds to a terminal 3, the control subinformation 3 corresponds to a terminal 4, the control subinformation 4 corresponds to a terminal 1, the control subinformation 5 corresponds to a terminal 5, and a plurality of pieces of control subinformation are located at different positions. For example, the terminal in this embodiment is the terminal 1. The terminal 1 needs to obtain the control subinformation 4. That is, the control subinformation 4 is target control subinformation. The second control information transmission mode, that is, the single control information transmission indicates that the first control information corresponds to one terminal.

The following separately describes different cases of types of parameters included in a parameter set.

1. The parameter in the parameter set includes control resource set configuration information.

When the parameter in the parameter set includes the control resource set configuration information, the base station may send a plurality of pieces of control resource set configuration information to the terminal, and indicate a mapping relationship, that is, a correspondence between the M time periods and the control resource set configuration information.

For example, in the mapping relationship, the control resource set configuration information changes with time. For example, M pieces of control resource set configuration information corresponding to the M time periods may be configured. Identifiers of the plurality of pieces of control resource set configuration information may be arranged in a sequence. For example, if an identifier corresponding to the control resource set configuration information 1 is 1, an identifier corresponding to the control resource set configuration information 2 is 2, an identifier corresponding to the control resource set configuration information 3 is 3, an identifier corresponding to the control resource set configuration information 4 is 4, and an identifier corresponding to the control resource set configuration information 5 is 5, an identifier character string may be obtained in a sequence of 1, 2, 3, 4, and 5, or may be obtained in another sequence, for example, 2, 3, 5, 4, and 1. This is not limited. The identifier character string indicates a sequence of the control resource set configuration information in time, and the mapping relationship includes the identifier character string. Because the time periods are also arranged in a sequence, the identifier character string may indicate a mapping relationship between the parameter sets and the time periods. In actual implementation, the identifier character string may alternatively be arranged in another sequence. This is not limited herein.

For example, based on the embodiment shown in FIG. 7h, when a identifier character string corresponding to control resource set configuration information in the mapping relationship is 1, 2, 3, 4, and 5, a time period 1 corresponds to the parameter set 1, the parameter set 1 includes the control resource set configuration information 1, a time period 2 corresponds to the parameter set 2, the parameter set 2 includes the control resource set configuration information 2, a time period 3 corresponds to the parameter set 3, the parameter set 3 includes the control resource set configuration information 3, a time period 4 corresponds to the parameter set 4, the parameter set 4 includes the control resource set configuration information 4, a time period 5 corresponds to the parameter set 5, and the parameter set 5 includes the control resource set configuration information 5.

Optionally, the base station may indicate a correspondence between the M time periods and the control resource set configuration information to the terminal.

For example, the base station sends a plurality of pieces of control resource set configuration information to the terminal and indicates a correspondence between time periods and the control resource set configuration information. For example, the control resource set configuration information changes with time, and a time granularity may be one or more symbols, one or more slots, one or more subframes, or the like.

For example, a correspondence between a time period and the control resource set configuration information is 0, 3, 2, 1, or the like. The terminal may determine that control resource set configuration information corresponding to the 1st time period is the control resource set configuration information 0, control resource set configuration information corresponding to the 2nd time period is the control resource set configuration information 3, control resource set configuration information corresponding to the 3rd time period is the control resource set configuration information 2, and control resource set configuration information corresponding to the 4th time period is the control resource set configuration information 1.

Further, the base station may configure a block identifier (block index) and/or a terminal identifier (UE index) of scheduling information of the terminal in group control information for the terminal. The foregoing configuration may be configured for each piece of control resource set configuration information. That is, there is a correspondence between the control resource set configuration information and the block identifier information and/or the terminal identifier, so that a paired UE group changes with time.

It should be noted that when the parameter in the parameter set includes the control resource set configuration information, there may be a correspondence between the control resource set configuration information and a beam. The beam may be a beam that can achieve best communication quality. For example, the control resource set configuration information 1 corresponds to a beam 1, the control resource set configuration information 2 corresponds to a beam 2, the control resource set configuration information 3 corresponds to a beam 3, the control resource set configuration information 4 corresponds to a beam 4, and the control resource set configuration information 5 corresponds to a beam 5. When obtaining the control resource set configuration information corresponding to the time periods, the terminal also obtains corresponding beam information. It should be noted that the beam 1, the beam 2, the beam 3, the beam 4, and the beam 5 may be identifiers of the beams.

It should be noted that the control resource set configuration information 1, the control resource set configuration information 2, the control resource set configuration information 3, the control resource set configuration information 4, and the control resource set configuration information 5 may be the same, or may be different, or may be partially the same, or may be partially different. This is not limited herein.

Optionally, the control resource set configuration information may include a control resource set identifier. There may be a correspondence between the control resource set identifiers and the beam identifiers.

For example, a control resource set identifier 1 corresponds to the beam 1, a control resource set identifier 2 corresponds to the beam 2, a control resource set identifier 3 corresponds to the beam 3, and a control resource set identifier 4 corresponds to the beam 4.

Optionally, in this embodiment, the beam may be a transmit beam, or may be a receive beam. In communication, a transmit end may send a signal by using the transmit beam, and a receive end may receive a signal by using the receive beam. The transmit end may determine the transmit beam, and further transmit the signal by using the transmit beam. The receive end may determine the receive beam, and further receive the signal by using the receive beam.

Optionally, there is a correspondence between the transmit beam and the receive beam. The receive end may determine the receive beam based on the transmit beam.

Optionally, at least one of the terminal and the base station may determine, based on the mapping relationship and a correspondence between the control resource set configuration information and the beams, beams corresponding to the M time periods, to implement beam communication, and improve communication performance.

In this embodiment, dynamic terminal pairing can be implemented, control information can be transmitted more flexibly, and the terminal can be dynamically scheduled, so that a beam switching latency is reduced, and communication performance is improved.

The parameter in the parameter set includes an RNTI.

When the parameter in the parameter set includes the RNTI, the base station may configure a plurality of RNTIs for the terminal, and indicate a mapping relationship, that is, a correspondence between the M time periods and the RNTIs.

The RNTI may be a group RNTI and may identify a group of terminals. The group of terminals includes one or more terminals.

For example, in the mapping relationship, the RNTIs change with time. For example, M RNTIs corresponding to the M time periods may be configured. Identifiers of the plurality of RNTIs may be arranged in a sequence. For example, if an identifier corresponding to an RNTI 1 is 6, an identifier corresponding to an RNTI 2 is 7, an identifier corresponding to an RNTI 3 is 8, an identifier corresponding to an RNTI 4 is 9, and an identifier corresponding to an RNTI 5 is 0, an identifier character string may be obtained in a sequence of 6, 7, 8, 9, and 0, or may be obtained in another sequence, for example, 7, 9, 8, 0, or 6. This is not limited. The identifier character string indicates a sequence of the RNTIs in time, and the mapping relationship includes the identifier character string. Because the time periods are also arranged in a sequence, the identifier character string may indicate a mapping relationship between the parameter sets and the time periods. In actual implementation, the identifier character string may alternatively be arranged in another sequence. This is not limited herein.

For example, based on the embodiment shown in FIG. 7g, when an identifier character string corresponding to RNTIs in the mapping relationship is 6, 7, 8, 9, and 0, a time period 1 corresponds to the parameter set 1, the parameter set 1 includes the RNTI 1, a time period 2 corresponds to the parameter set 2, the parameter set 2 includes the RNTI 2, a time period 3 corresponds to the parameter set 3, the parameter set 3 includes the RNTI 3, a time period 4 corresponds to the parameter set 4, the parameter set 4 includes the RNTI 4, a time period 5 corresponds to the parameter set 5, and the parameter set 5 includes the RNTI 5.

Optionally, the base station may indicate a correspondence between the M time periods and the RNTIs to the terminal.

Method 1: The base station sends one piece of control resource set configuration information to the terminal, where the control resource set configuration information corresponds to a plurality of RNTIs; and indicates a correspondence between the time periods and the RNTIs. For example, the RNTIs change with time, and a time granularity may be one or more symbols, one or more slots, one or more subframes, or the like.

Method 2: The base station sends a plurality of pieces of control resource set configuration information to the terminal, where one piece of control resource set configuration information corresponds to one RNTI; and indicates a correspondence between the time periods and the RNTIs. For example, the RNTIs change with time, and a time granularity may be one or more symbols, one or more slots, one or more subframes, or the like.

For example, a correspondence between a time period and the RNTI is 0, 3, 2, 1, or the like. The terminal may determine that an RNTI corresponding to the 1st time period is the RNTI 0, an RNTI corresponding to the 2nd time period is the RNTI 3, an RNTI corresponding to the 3rd time period is the RNTI 2, and an RNTI corresponding to the 4th time period is the RNTI 1.

Further, the base station may configure block identifier information (for example, a block index) and/or a terminal identifier (for example, a UE index) of scheduling information of the terminal in group control information for the terminal. The foregoing configuration may be configured for each RNTI. That is, there is a correspondence between the RNTI and the block identifier information and/or the terminal identifier, so that a paired UE group changes with time.

It should be noted that when the parameter in the parameter set includes the RNTI, there may be a correspondence between the RNTI and a beam. The beam may be a beam that can achieve best communication quality. For example, the RNTI 1 corresponds to a beam 1, the RNTI 2 corresponds to a beam 2, the RNTI 3 corresponds to a beam 3, the RNTI 4 corresponds to a beam 4, and the RNTI 5 corresponds to a beam 5. When obtaining the RNTIs corresponding to the time periods, the terminal also obtains corresponding beam information. It should be noted that the beam 1, the beam 2, the beam 3, the beam 4, and the beam 5 may be identifiers of the beams.

It should be noted that the RNTI 1, the RNTI 2, the RNTI 3, the RNTI 4, and the RNTI 5 may be the same, or may be different, or may be partially the same, or may be partially different. This is not limited herein.

Optionally, in this embodiment, the beam may be a transmit beam, or may be a receive beam. In communication, a transmit end may send a signal by using the transmit beam, and a receive end may receive a signal by using the receive beam. The transmit end may determine the transmit beam, and further transmit the signal by using the transmit beam. The receive end may determine the receive beam, and further receive the signal by using the receive beam.

Optionally, there is a correspondence between the transmit beam and the receive beam. The receive end may determine the receive beam based on the transmit beam.

Optionally, at least one of the terminal and the base station may determine, based on the mapping relationship and a correspondence between the RNTIs and the beams, beams corresponding to the M time periods, to implement beam communication, and improve communication performance.

In this embodiment, dynamic terminal pairing can be implemented, control information can be transmitted more flexibly, and the terminal can be dynamically scheduled, so that a beam switching latency is reduced, and communication performance is improved.

3. The parameter in the parameter set includes reference signal configuration information.

When the parameter in the parameter set includes the reference signal configuration information, the base station may send a plurality of pieces of reference signal configuration information to the terminal, and indicate a mapping relationship, that is, a correspondence between the M time periods and the reference signal configuration information.

For example, in the mapping relationship, the reference signal configuration information changes with time. For example, M pieces of reference signal configuration information corresponding to the M time periods may be configured. Identifiers of the plurality of pieces of reference signal configuration information may be arranged in a sequence. For example, if an identifier corresponding to reference signal configuration information 1 is 11, an identifier corresponding to reference signal configuration information 2 is 12, an identifier corresponding to reference signal configuration information 3 is 13, an identifier corresponding to reference signal configuration information 4 is 14, and an identifier corresponding to reference signal configuration information 5 is 15, an identifier character string may be obtained in a sequence of 11, 12, 13, 14, and 15, or may be obtained in another sequence, for example, 12, 14, 13, 11, and 15. This is not limited. The identifier character string indicates a sequence of the reference signal configuration information in time, and the mapping relationship includes the identifier character string. Because the time periods are also arranged in a sequence, the identifier character string may indicate a mapping relationship between the parameter sets and the time periods. In actual implementation, the identifier character string may alternatively be arranged in another sequence. This is not limited herein.

For example, based on the embodiment shown in FIG. 7g, when the identifier character string corresponding to the reference signal configuration information in the mapping relationship is 11, 12, 13, 14, or 15, a time period 1 corresponds to the parameter set 1, the parameter set 1 includes the reference signal configuration information 1, a time period 2 corresponds to the parameter set 2, the parameter set 2 includes the reference signal configuration information 2, a time period 3 corresponds to the parameter set 3, the parameter set 3 includes the reference signal configuration information 3, a time period 4 corresponds to the parameter set 4, the parameter set 4 includes the reference signal configuration information 4, a time period 5 corresponds to the parameter set 5, and the parameter set 5 includes the reference signal configuration information 5.

Optionally, the base station may indicate a correspondence between the M time periods and the reference signal configuration information to the terminal.

Method 1: The base station sends one piece of control resource set configuration information to the terminal, where the one piece of control resource set configuration information corresponds to a plurality of pieces of reference signal configuration information; and indicates a correspondence between the time periods and the reference signal configuration information. For example, the reference signal configuration information changes with time, and a time granularity may be one or more symbols, one or more slots, one or more subframes, or the like.

Method 2: The base station sends a plurality of pieces of control resource set configuration information to the terminal, where one piece of control resource set configuration information corresponds to one of piece of reference signal configuration information; and indicates a correspondence between the time periods and the reference signal configuration information. For example, the reference signal configuration information changes with time, and a time granularity may be one or more symbols, one or more slots, one or more subframes, or the like.

For example, a correspondence between a time period and the reference signal configuration information is 0, 3, 2, 1, or the like. The terminal may determine that reference signal configuration information corresponding to the 1st time period is reference signal configuration information 0, reference signal configuration information corresponding to the 2nd time period is reference signal configuration information 3, reference signal configuration information corresponding to the 3rd time period is reference signal configuration information 2, and reference signal configuration information corresponding to the 4th time period is reference signal configuration information 1.

Further, the base station may configure an information block identifier (block index) and/or a terminal identifier (UE index) of scheduling information of the terminal in group control information for the terminal. The foregoing configuration may be configured for each piece of reference signal configuration information. That is, there is a correspondence between the reference signal configuration information and block identifier information and/or the terminal identifier, so that a paired UE group changes with time.

It should be noted that when the parameter in the parameter set includes the reference signal configuration information, there may be a correspondence between the reference signal configuration information and a beam. The beam may be a beam that can achieve best communication quality. For example, the reference signal configuration information 1 corresponds to a beam 1, the reference signal configuration information 2 corresponds to a beam 2, the reference signal configuration information 3 corresponds to a beam 3, the reference signal configuration information 4 corresponds to a beam 4, and the reference signal configuration information 5 corresponds to a beam 5. When obtaining the reference signal configuration information corresponding to the time periods, the terminal also obtains corresponding beam information. It should be noted that the beam 1, the beam 2, the beam 3, the beam 4, and the beam 5 may be identifiers of the beams.

It should be noted that the reference signal configuration information 1, the reference signal configuration information 2, the reference signal configuration information 3, the reference signal configuration information 4, and the reference signal configuration information 5 may be the same, or may be different, or may be partially the same, or may be partially different. This is not limited herein.

Optionally, the reference signal configuration information may include a reference signal identifier. There may be a correspondence between the reference signal identifier and the beam identifier.

For example, a reference signal identifier 1 corresponds to a beam 1, a reference signal identifier 2 corresponds to a beam 2, a reference signal identifier 3 corresponds to a beam 3, and a reference signal identifier 4 corresponds to a beam 4.

The reference signal identifiers may correspond to different pattern information of reference signals, or reference signal identifier information may correspond to different time-frequency resource information of reference signals, or reference signal identifier information may correspond to different sequences of reference signals.

For example, FIG. 7l shows reference signal pattern information. A shadowed RE is an RE of a reference signal. For example, four patterns in FIG. 7l are respectively (a), (b), (c) and (d), and the pattern indicates a RE on which a time-frequency resource of a reference signal is located. Pattern identifiers corresponding to the four patterns may respectively be 0, 1, 2, and 3. The network device indicates the pattern identifiers, and the terminal device may determine, based on the pattern identifiers, a RE on which a time-frequency resource of a first reference signal is located.

Optionally, in this embodiment, the beam may be a transmit beam, or may be a receive beam. In communication, a transmit end may send a signal by using the transmit beam, and a receive end may receive a signal by using the receive beam. The transmit end may determine the transmit beam, and further transmit the signal by using the transmit beam. The receive end may determine the receive beam, and further receive the signal by using the receive beam.

Optionally, there is a correspondence between the transmit beam and the receive beam. The receive end may determine the receive beam based on the transmit beam.

Optionally, at least one of the terminal and the base station may determine, based on the mapping relationship and a correspondence between the control resource set configuration information and the beams, beams corresponding to the M time periods, to implement beam communication, and improve communication performance.

In this embodiment, dynamic terminal pairing can be implemented, control information can be transmitted more flexibly, and the terminal can be dynamically scheduled, so that a beam switching latency is reduced, and communication performance is improved.

4. The parameter in the parameter set includes a control information transmission mode.

When the parameter in the parameter set includes the control information transmission mode, the base station may send configuration information of the control information transmission mode to the terminal, and indicate a mapping relationship, that is, a correspondence between the M time periods and the control information transmission modes.

For example, in the mapping relationship, the control information transmission mode changes with time. For example, M control information transmission modes corresponding to the M time periods may be configured. Identifiers of a plurality of control information transmission modes may be arranged in a sequence. For example, if an identifier corresponding to a first control information transmission mode is 21, and an identifier corresponding to a second control information transmission mode is 22, an identifier character string may be obtained in a sequence of 21, 22, 21, 22, and 21, or may be obtained in another sequence, for example, 22, 22, 21, 22, and 21. This is not limited. The identifier character string indicates a sequence of the control information transmission modes in time, and the mapping relationship includes the identifier character string. Because the time periods are also arranged in a sequence, the identifier character string may indicate a mapping relationship between the parameter sets and the time periods. In actual implementation, the identifier character string may alternatively be arranged in another sequence. This is not limited herein.

For example, based on the embodiment shown in FIG. 7g, when an identifier character string corresponding to control information transmission modes in the mapping relationship is 21, 22, 21, 22, and 21, a time period 1 corresponds to the parameter set 1, the parameter set 1 includes the first control information transmission mode, a time period 2 corresponds to the parameter set 2, the parameter set 2 includes the second control information transmission mode, a time period 3 corresponds to the parameter set 3, the parameter set 3 includes the first control information transmission mode, a time period 4 corresponds to the parameter set 4, the parameter set 4 includes the second control information transmission mode, a time period 5 corresponds to the parameter set 5, and the parameter set 5 includes the first control information transmission mode.

Optionally, the base station may determine, based on a periodic service feature of the terminal, whether to use a single control information transmission mode or a group control information transmission mode. For example, when a larger quantity of terminals are scheduled, the group control information transmission mode is used. When a smaller quantity of terminals are scheduled, the single control information transmission mode is used.

Optionally, the terminal may detect single control information and/or group control information based on an indication of the base station.

For example, when detecting the group control information in the 1st symbol, the terminal does not need to detect the single control information. When the terminal does not detect the group control information, if the terminal is configured to detect the single control information, the terminal may detect the single control information on the 2nd symbol.

The base station may configure the correspondence between the time periods and the control information transmission modes for the terminal.

Method 1: The single control information transmission mode and the group control information transmission mode correspond to different time domain resources.

For example, if one control resource set includes two symbols, group control information transmission is used on the 1st symbol, and single control information transmission is used on the 2nd symbol.

Method 2: The single control information transmission mode and the group control information transmission mode correspond to different RNTIs.

For example, the base station may configure an RNTI-1 of the single control information and an RNTI-2 of the group control information for the terminal in one piece of control resource set configuration information. The terminal detects the single control information by using the RNTI-1 and detects the group control information by using the RNTI-2.

In this embodiment, a transmission mode of the single control information and a transmission mode of the group control information can be dynamically switched based on the time period, so that control information overheads are reduced, and the control information is transmitted based on an actual scheduling status, so that communication performance is improved.

5. The parameter set includes a plurality of parameters.

When the parameters in the parameter set include a plurality of types of parameters, for example, the parameter set includes control resource set configuration information, an RNTI, reference signal configuration information, and a control information transmission mode, identifier character strings corresponding to various parameters may be configured in a mapping relationship. For example, an identifier character string of 1, 2, 3, 4, and 5 corresponding to the control resource set configuration information is configured; an identifier character string of 6, 7, 8, 9, and 0 corresponding to the RNTI is configured; an identifier character string of 11, 12, 13, 14, and 15 corresponding to reference signal configuration information is configured; and an identifier character string of 21, 22, 21, 22, and 21 corresponding to the control information transmission mode is configured. For example, based on the embodiment shown in FIG. 7h, when the mapping relationship includes the foregoing identifier character strings, the parameter set 1 includes control resource set configuration information 1, an RNTI 1, reference signal configuration information 1, and a control information transmission mode 1, the parameter set 2 includes control resource set configuration information 2, an RNTI 2, reference signal configuration information 2, and a control information transmission mode 2, the parameter set 3 includes control resource set configuration information 3, an RNTI 3, reference signal configuration information 3, and a control information transmission mode 1, the parameter set 4 includes control resource set configuration information 4, an RNTI 4, reference signal configuration information 4, and a control information transmission mode 2, and the parameter set 5 includes control resource set configuration information 5, an RNTI 5, reference signal configuration information 5, and a control information transmission mode 1.

The foregoing is merely an example. In actual implementation, there may be another implementation.

Optionally, there is a correspondence between the control resource set configuration information and at least one of the RNTI, the reference signal configuration information, and the control information transmission mode.

Optionally, the terminal receives a plurality of pieces of control resource set configuration information, where one of the plurality of pieces of control resource set configuration information corresponds to at least one of one RNTI, one piece of reference signal configuration information, and one control information transmission mode. For example, one piece of control resource set configuration information includes at least one of one RNTI, one piece of reference signal configuration information, and one control information transmission mode.

For example, all pieces of control resource configuration information in the parameter set 1 to the parameter set 5 are the control resource configuration information 1, the parameter set 1 includes the RNTI 1, the parameter set 2 includes the RNTI 2, the parameter set 3 includes the RNTI 3, the parameter set 4 includes the RNTI 4, and the parameter set 5 includes the RNTI 5.

Optionally, the terminal receives one piece of control resource set configuration information, where the control resource set configuration information corresponds to at least one of at least two RNTIs, two pieces of reference signal configuration information, and at least two control information transmission modes. For example, one piece of control resource set configuration information includes at least one of at least two RNTIs, at least two pieces of reference signal configuration information, and at least two control information transmission modes.

Alternatively, all pieces of control resource configuration information in the parameter set 1 to the parameter set 5 are the control resource configuration information 1, the parameter set 1 includes the reference signal configuration information 1, the parameter set 2 includes the reference signal configuration information 2, the parameter set 3 includes the reference signal configuration information 3, the parameter set 4 includes the reference signal configuration information 4, and the parameter set 5 includes the reference signal configuration information 5.

Optionally, in actual implementation, if the transmission mode of the first control information is the first control information transmission mode, there may be an association relationship between the control resource set configuration information and a position of target control subinformation in the first control information. In other words, the position of the target control subinformation in the first control information may be determined based on the control resource set configuration information.

Optionally, the terminal determines an information block position of control subinformation of the terminal in the first control information, and there is a correspondence between the information block position and the parameter set.

For example, the terminal may determine the information block position of the control subinformation of the terminal in the first control information based on a value of a parameter in the parameter set.

Optionally, in actual implementation, if the transmission mode of the first control information is the first control information transmission mode, there may be an association relationship between the RNTI and a position of target control subinformation in the first control information. In other words, the position of the target control subinformation in the first control information may be determined based on the RNTI.

Optionally, in actual implementation, if the transmission mode of the first control information is the first control information transmission mode, there may be an association relationship between the reference signal configuration information and a position of target control subinformation in the first control information. In other words, the position of the target control subinformation in the first control information may be determined based on the reference signal configuration information.

Optionally, there may be a correspondence between the control information transmission mode and the time-frequency position of the first control information. For example, the 1st symbol and the 2nd symbol are included in a time-frequency resource indicated by the control resource set configuration information. When the transmission mode of the first control information is the first control information transmission mode, the first control information is located on the 1st symbol. When the transmission mode of the first control information is the second control information transmission mode, the first control information is located on the 2nd symbol.

Optionally, there may be a correspondence between the first control information transmission mode and the RNTI. For example, when the transmission mode of the first control information is the first control information transmission mode, a value of the RNTI is the RNTI 1; or when the transmission mode of the first control information is the second control information transmission mode, a value of the RNTI is the RNTI 2.

It should be noted that the parameter set 1, the parameter set 2, the parameter set 3, the parameter set 4, and the parameter set 5 may be the same, or may be different, or may be partially the same, or may be partially different. This is not limited herein.

Optionally, the at least one of the RNTI, the reference signal configuration information, and the control information transmission mode may alternatively be configured in the control resource set configuration information. For example, if the RNTI 1 and the control resource set configuration information 1 correspond to a time period 1, the RNTI 1 may be configured in the control resource set configuration information 1. In other words, there is a correspondence between the control resource set configuration information 1 and the RNTI 1. When determining that there is the correspondence between the control set configuration information 1 and the time period 1, the terminal also determines that there is a correspondence between the RNTI 1 and a time period 1. Therefore, an identifier character string indicating a mapping relationship between the RNTI 1 and the time period 1 does not need to be set.

It may be understood that the terminal needs to obtain a correspondence between each identifier character and a value of a parameter. For example, when obtaining an identifier character “1” of control resource set configuration information, the terminal may determine that the identifier character “1” corresponds to the control resource set configuration information 1. For example, when obtaining an identifier character “6” of an RNTI, the terminal may determine that the identifier character “6” corresponds to the RNTI 6. For example, when obtaining an identifier character “11” of reference signal configuration information, the terminal may determine that the identifier character “11” corresponds to the reference signal configuration information 11. The correspondence between the identifier character and the value of the parameter may be preconfigured in the terminal or may be obtained by the terminal together with a mapping relationship.

602: The terminal receives the first control information in the first time period based on the mapping relationship.

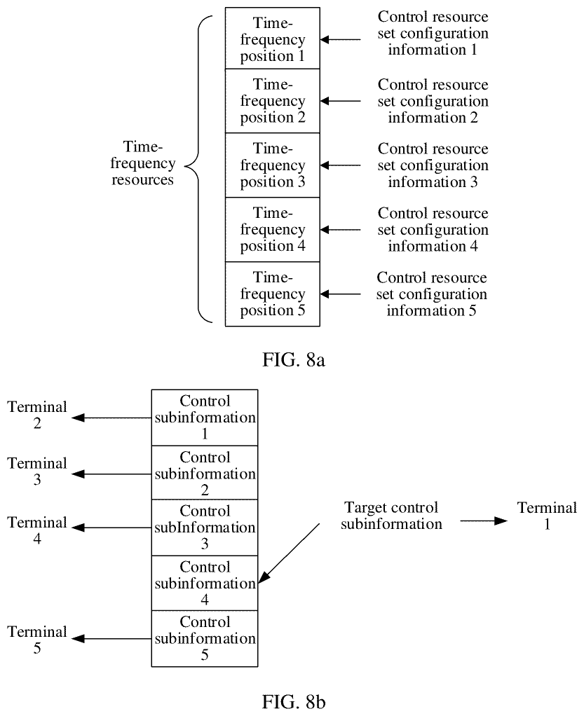

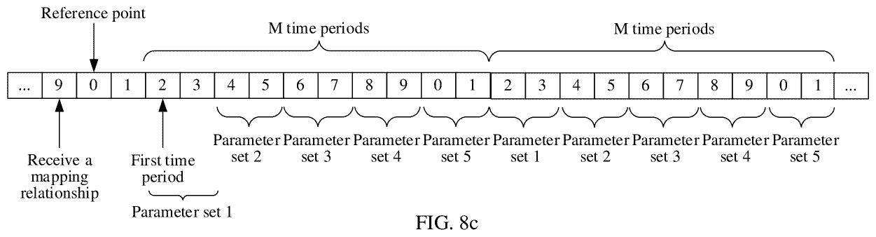

After obtaining the mapping relationship, the terminal receives the first control information from the base station in the first time period based on the mapping relationship, where the first control information is used to schedule transmission of a communication signal. For example, see the embodiment shown in FIG. 7h or FIG. 8c. The terminal receives the first control information based on the mapping relationship in a subframe 2 shown in FIG. 8c, where the subframe 2 is a first time period.

It can be understood from the mapping relationship that a parameter set corresponding to the subframe 2 is the parameter set 1. For example, the parameter set 1 includes control resource set configuration information 1, an RNTI 1, reference signal configuration information 1, and a control information transmission mode 1. The terminal may determine, based on the reference signal configuration information 1, a time-frequency position and/or a sequence corresponding to a reference signal, to perform channel estimation.

Optionally, the network device and/or the terminal may determine a resource granularity of joint channel estimation of the control information. The resource granularity may be a quantity of CCEs or a quantity of REGs. For example, the resource granularity of the channel estimation may be N1 CCEs or N2 resource element groups (REGs), where N1 and N2 are integers greater than 0.

Optionally, the terminal receives indication information, where the indication information indicates the resource granularity of the channel estimation. Correspondingly, the network device may send the indication information.

The terminal determines, based on the control resource set configuration information 1, the time-frequency position corresponding to the first control information, and performs blind detection on the first control information based on the RNTI 1, to obtain the first control information.

When the transmission mode of the first control information is a first control information transmission mode, the terminal needs to obtain a position of target control subinformation in the first control information, where the target control subinformation is control subinformation corresponding to the terminal. The base station may send, to the terminal, an identifier corresponding to the target control subinformation, and the terminal obtains the target control subinformation based on the identifier. Alternatively, the base station may alternatively send, to the terminal, an identifier of each terminal that needs to be scheduled by using the first control information, and a correspondence between each terminal that needs to be scheduled and a position of control subinformation, so that each terminal determines a position of respective corresponding control subinformation.

Alternatively, if there is a correspondence between at least one of the control resource set configuration information 1, the reference signal configuration information 1, and the RNTI 1 and the position of the target control subinformation in the first control information, the terminal may alternatively determine the position of the target control subinformation in the first control information based on the correspondence.

Alternatively, the terminal may determine the position of the target control subinformation based on a value of at least one parameter in the parameter set. In other words, there is an association relationship between the value of the at least one parameter in the parameter set and the position of the target control subinformation. For example, the RNTI 1 in the parameter set 1 is used as an example. There may be an association relationship between the RNTI 1 and the position of the target control subinformation. In other words, after obtaining the RNTI 1, the terminal may determine the position of the target control subinformation.

Optionally, the control information corresponding to the first control information transmission mode and control information corresponding to a second control information transmission mode have different time-frequency positions. For example, when the first control information transmission mode is used, the first control information may be located in the 1st time domain symbol in the time-frequency position indicated by the control resource set configuration information 1. When the second control information transmission mode is used, the first control information may be located in the 2nd time domain symbol in the time-frequency position indicated by the control resource set configuration information 1.

Optionally, there may alternatively be an association relationship between the control information transmission mode and a value of the RNTI. For example, when the control information transmission mode 1 is used, correspondingly, blind detection may be performed on the first control information by using the RNTI 1. When the control information transmission mode 2 is used, correspondingly, blind detection may be performed on the first control information by using an RNTI 2.

Optionally, there may alternatively be a correspondence between the parameter set and a beam that can achieve best communication quality. After determining the value of the parameter in the parameter set, the terminal may determine the corresponding beam based on the correspondence, so that communication is directly performed based on the beam, and steps such as beam tracking and beam scanning do not need to be performed, thereby reducing a communication latency of the terminal. For example, the terminal determines a corresponding beam 1 based on the control resource set configuration information 1, the RNTI 1, the reference signal configuration information 1, and the control information transmission mode 1 in the parameter set 1, so that communication may be performed in the subframe 2 and a subframe 3 based on the beam 1.

It should be noted that different DCI may have different purposes, for example, includes DCI used for allocating a transmission resource in uplink or downlink, DCI used for adjusting uplink power through control, and DCI for downlink dual-stream spatial multiplexing. The DCI for different purposes may be distinguished from each other in different DCI formats. In actual implementation, information used for scheduling signal transmission may be classified into three types, and the control information may include at least one of the three types of information. The first-type information is information used to perform channel estimation, for example, information indicating time-frequency resource positions and information indicating a sequence of demodulation reference signals.

The second-type information is information used to decode a physical downlink shared channel (PDSCH), for example, a modulation and coding scheme (MCS), a HARQ process number, and a new data indicator (NDI).

The third-type information is information used to send uplink control information (UCI), for example, a PUCCH resource, transmit power control (TPC), code block group transmission information (CBG) configuration, channel state information (CSI) trigger information, and sounding reference signal (SRS) trigger information.

To reduce complexity of blind detection performed by the terminal, the first-type information may be transmitted as first-type control information, the second-type information may be transmitted as second-type control information, and the third-type information may be transmitted as third-type control information; or the first-type information and the second-type information are transmitted as first-type control information, and the third-type information is transmitted as second-type control information; or the first-type information is transmitted as first-type control information, and the second-type information and the third-type information are transmitted as second-type control information. The information included in the DCI is partially transmitted, so that the terminal device can process different types of information in parallel, thereby reducing a communication latency.

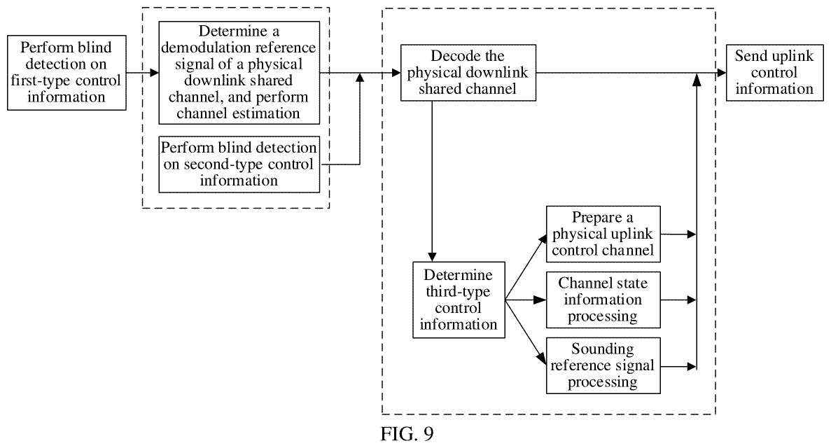

As shown in FIG. 9, first-type information is used as first DCI, second-type information is used as second DCI, and third-type information is used as third DCI. In this case, the terminal device may implement parallel processing of performing channel estimation and blind detection on the second DCI, and/or parallel processing of decoding a PDSCH and determining the third DCI, and/or parallel processing of decoding a PDSCH and preparing a PUCCH, CSI processing, and SRS processing. That is, after blind detection is performed on first-type control information, a demodulation reference signal of a physical downlink shared channel may be determined, and channel estimation is performed. In this case, performing blind detection on second-type control information may be performed synchronously with performing channel estimation. Then, the PDSCH is decoded. In this case, decoding the PDSCH may be performed synchronously with determining third-type control information, or decoding the PDSCH may be performed synchronously with determining third-type control information, preparing the PUCCH, the CSI processing, and the SRS processing, and finally UCI is sent, so that a communication latency is reduced.

The first control information may be at least one of the first-type control information, the second-type control information, and the third-type control information.

603: The terminal receives the second control information in a second time period based on the mapping relationship.

The terminal receives the second control information in the second time period based on the mapping relationship. The second time period may be a subframe after the foregoing subframe 2, for example, may be a next subframe 4 of the subframe 2. In this case, the terminal determines, in the subframe 4 based on the mapping relationship, that the second control information needs to be received based on a parameter set 2.

It may be understood that control information does not need to be received based on a value in the parameter set in all the time periods. The first control information is received based on the parameter set 1 in the first time period, that is, the subframe 2. Because the next subframe, such as the subframe 3, also corresponds to the parameter set 1, the control information may not be received in the subframe 3, but a service is performed.

It should be noted that step 603 is an optional step and may alternatively not be performed in actual implementation.

In this embodiment, the terminal may determine, based on a mapping relationship, parameter sets corresponding to time periods, and receive the control information in the time period based on the corresponding parameter set. In addition, because there is a correspondence between the parameter set and a beam, the terminal may determine, based on the parameter set, the beam that can achieve best communication quality, so that a communication latency is reduced.

The foregoing describes the communication method in the embodiments. The following describes a terminal in an embodiment.

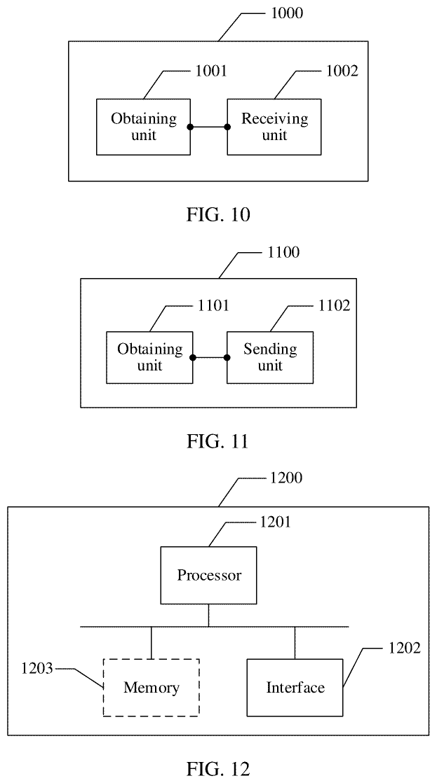

As shown in FIG. 10, the terminal 1000 in this embodiment includes an obtaining unit 1001 and a receiving unit 1002.

The obtaining unit 1001 is configured to obtain a mapping relationship, where the mapping relationship includes a mapping relationship between M parameter sets and M time periods, the parameter set includes a value of at least one parameter, and M is an integer greater than or equal to 2.

The receiving unit 1002 is configured to receive first control information in a first time period based on the mapping relationship, where the first time period is included in the M time periods.

Based on the foregoing embodiment shown in FIG. 10,

In a possible implementation, there may be a correspondence between the parameter set and a beam.

In this embodiment, the beam may be a beam that can achieve best communication quality. The terminal also determines the beam corresponding to the time period when determining the parameter set corresponding to the time period, and therefore directly determines the optimal beam without performing beam scanning and beam tracking, so that a communication latency is reduced.

In a possible implementation, the at least one parameter in different parameter sets in the M parameter sets has different values.

In a possible implementation, the parameter in the parameter set includes at least one of control resource set configuration information, a radio network temporary identifier (RNTI), reference signal configuration information, and a control information transmission mode.

In a possible implementation, the control resource set configuration information indicates a time-frequency position corresponding to the first control information, the radio network temporary identifier is used to parse the first control information, the reference signal configuration information indicates a time-frequency position and/or a sequence corresponding to a reference signal, and the control information transmission mode indicates a transmission mode of the first control information.

In a possible implementation, the control resource set configuration information is used to configure a control resource set, the radio network temporary identifier identifies a terminal device, the reference signal configuration information is used to configure a reference signal, and the control information transmission mode indicates a transmission mode of the control information.

In a possible implementation, the time period includes any one of one or more time domain symbols, one or more slots, and one or more subframes.

In a possible implementation, the control information transmission mode includes a first control information transmission mode and a second control information transmission mode, the first control information transmission mode indicates that the first control information includes a plurality of pieces of control subinformation, the plurality of pieces of control subinformation respectively correspond to a plurality of terminals, and the second control information transmission mode indicates that the first control information corresponds to one terminal.

In a possible implementation, the control information transmission mode includes group control information transmission and single control information transmission.

In a possible implementation, the first control information is used for scheduling signal transmission.

In a possible implementation, there is a correspondence between the control resource set configuration information and at least one of the RNTI, the reference signal configuration information, and the control information transmission mode.

In a possible implementation, if the first control information includes the plurality of pieces of control subinformation, there is a correspondence between a position of target control subinformation in the plurality of pieces of control subinformation in the first control information and the value of the at least one parameter.

In a possible implementation, if the first control information includes the plurality of pieces of control subinformation, the position of the target control subinformation in the first control information is determined based on the value of the at least one parameter.

In a possible implementation, the terminal performs channel estimation on the first control information based on a resource granularity of channel estimation, where the resource granularity of the channel estimation is N₁ control channel elements (CCEs) or N₂ resource element groups (REGs), and N₁ and N₂ are integers greater than 0.

In a possible implementation, there is an association relationship between the time periods and a time periodicity and a time offset; or there is an association relationship between the time periods and a time start position and a time length.

In a possible implementation, the terminal determines the time periods based on the time periodicity and the time offset; or determines the time periods based on the time start position and the time length.

In a possible implementation, there is an association relationship between the mapping relationship and the time periodicity, the time offset, and a time interval; or there is an association relationship between the mapping relationship and the time start position, the time length, and a time interval.

In a possible implementation, the mapping relationship is determined based on the time periodicity, the time offset, and the time interval; or the mapping relationship is determined based on the time start position, the time length, and the time interval.

The following describes a base station in an embodiment.

As shown in FIG. 11, the network device 1100 in this embodiment includes an obtaining unit 1101 and a sending unit 1102.

The obtaining unit 1101 is configured to obtain a mapping relationship, where the mapping relationship includes a mapping relationship between M parameter sets and M time periods, the parameter set includes a value of at least one parameter, and M is an integer greater than or equal to 2.

The sending unit 1102 is configured to send first control information in a first time period based on the mapping relationship, where the first time period is included in the M time periods.

Based on the foregoing embodiment shown in FIG. 11,

In a possible implementation, there may be a correspondence between the parameter set and a beam.

In this embodiment, the beam may be a beam that can achieve best communication quality. The terminal also determines the beam corresponding to the time period when determining the parameter set corresponding to the time period, and therefore directly determines the optimal beam without performing beam scanning and beam tracking, so that a communication latency is reduced.

In a possible implementation, the at least one parameter in different parameter sets in the M parameter sets has different values.

In a possible implementation, the parameter in the parameter set includes at least one of control resource set configuration information, a radio network temporary identifier (RNTI), reference signal configuration information, and a control information transmission mode.

In a possible implementation, the control resource set configuration information indicates a time-frequency position corresponding to the first control information, the radio network temporary identifier is used to parse the first control information, the reference signal configuration information indicates a time-frequency position and/or a sequence corresponding to a reference signal, and the control information transmission mode indicates a transmission mode of the first control information.

In a possible implementation, the control resource set configuration information is used to configure a control resource set, the radio network temporary identifier identifies a terminal device, the reference signal configuration information is used to configure a reference signal, and the control information transmission mode indicates a transmission mode of the control information.

In a possible implementation, the time period includes any one of one or more time domain symbols, one or more slots, and one or more subframes.

In a possible implementation, the control information transmission mode includes a first control information transmission mode and a second control information transmission mode, the first control information transmission mode indicates that the first control information includes a plurality of pieces of control subinformation, the plurality of pieces of control subinformation respectively correspond to a plurality of terminals, and the second control information transmission mode indicates that the first control information corresponds to one terminal.

In a possible implementation, the control information transmission mode includes group control information transmission and single control information transmission.

In a possible implementation, the first control information is used for scheduling signal transmission.

In a possible implementation, there is a correspondence between the control resource set configuration information and at least one of the RNTI, the reference signal configuration information, and the control information transmission mode.

In a possible implementation, if the first control information includes the plurality of pieces of control subinformation, there is a correspondence between a position of target control subinformation in the plurality of pieces of control subinformation in the first control information and the value of the at least one parameter.

In a possible implementation, if the first control information includes the plurality of pieces of control subinformation, the position of the target control subinformation in the first control information is determined based on the value of the at least one parameter.

In a possible implementation, the terminal performs channel estimation on the first control information based on a resource granularity of channel estimation, where the resource granularity of the channel estimation is N₁ control channel elements (CCEs) or N₂ resource element groups REGs, and N₁ and N₂ are integers greater than 0.

In a possible implementation, there is an association relationship between the time periods and a time periodicity and a time offset; or there is an association relationship between the time periods and a time start position and a time length.

In a possible implementation, the terminal determines the time periods based on the time periodicity and the time offset; or determines the time periods based on the time start position and the time length.

In a possible implementation, there is an association relationship between the mapping relationship and the time periodicity, the time offset, and a time interval; or there is an association relationship between the mapping relationship and the time start position, the time length, and a time interval.

In a possible implementation, the mapping relationship is determined based on the time periodicity, the time offset, and the time interval; or the mapping relationship is determined based on the time start position, the time length, and the time interval.

FIG. 12 is another schematic diagram of a structure of a terminal according to an embodiment. As shown in FIG. 12, the communication apparatus 1200 includes a processor 1201 and an interface 1202. The processor 1201 is coupled to the interface 1202. The interface 1202 is configured to communicate with another device. The interface 1202 may be a transceiver or an input/output interface. For example, the interface 1202 may be an interface circuit. Optionally, the communication apparatus 1200 further includes a memory 1203, configured to store instructions executed by the processor 1201, store input data required for running instructions by the processor 1201, or store data generated after the processor 1201 runs instructions.

The method performed by the communication apparatus in the foregoing embodiment may be implemented by the processor 1201 by invoking a program stored in a memory (which may be the memory 1203 or may be an external memory). That is, the communication apparatus may include the processor 1201. The processor 1201 invokes the program in the memory to perform the method in the foregoing method embodiment. The processor herein may be an integrated circuit having a signal processing capability, for example, a CPU.

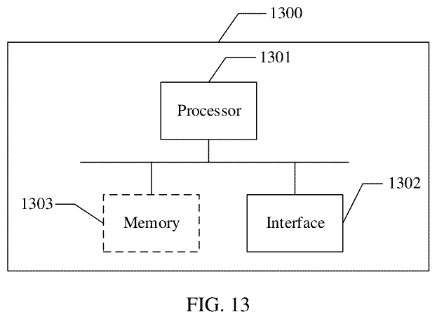

FIG. 13 is another schematic diagram of a structure of a base station according to an embodiment. As shown in FIG. 13, the communication apparatus 1300 includes a processor 1301 and an interface 1302. The processor 1301 is coupled to the interface 1302. The interface 1302 is configured to communicate with another device. The interface 1302 may be a transceiver or an input/output interface. For example, the interface 1302 may be an interface circuit. Optionally, the communication apparatus 1300 further includes a memory 1303, configured to store instructions executed by the processor 1301, store input data required for running instructions by the processor 1301, or store data generated after the processor 1301 runs instructions.

The method performed by the communication apparatus in the foregoing embodiment may be implemented by the processor 1301 by invoking a program stored in a memory (which may be the memory 1303 or may be an external memory). That is, the communication apparatus may include the processor 1301. The processor 1301 invokes the program in the memory to perform the method in the foregoing method embodiment. The processor herein may be an integrated circuit having a signal processing capability, for example, a CPU.

It may be understood by a person skilled in the art that, for the purpose of convenient and brief description, for a detailed working process of the foregoing system, apparatus, and unit, refer to a corresponding process in the foregoing method embodiments. Details are not described herein again.

In several embodiments, it should be understood that the system, apparatus, and method may be implemented in another manner. For example, the described apparatus embodiment is merely an example. For example, division into units is merely logical function division and may be other division in actual implementation. For example, a plurality of units or components may be combined or integrated into another system, or some features may be ignored or not performed. In addition, the displayed or discussed mutual couplings or direct couplings or communication connections may be implemented through some interfaces. The indirect couplings or communication connections between the apparatuses or units may be implemented in electronic, mechanical, or another form.

The units described as separate components may or may not be physically separate, and components displayed as units may or may not be physical units, may be located in one position, or may be distributed on a plurality of network units. Some or all of the units may be selected based on an actual requirement to achieve the objectives of the embodiments.

In addition, functional units in the embodiments may be integrated into one processing unit, each of the units may exist alone physically, or two or more units are integrated into one unit. The integrated unit may be implemented in a form of hardware or may be implemented in a form of a software functional unit.

When the integrated unit is implemented in the form of the software functional unit and sold or used as an independent product, the integrated unit may be stored in a non-transitory computer-readable storage medium. Based on such an understanding, the solutions essentially, or the part contributing to a conventional technology, or all or some of the solutions may be implemented in the form of a software product. The computer software product is stored in a storage medium and includes several instructions for instructing a computer device (which may be a personal computer, a server, or a network device) to perform all or some of the steps of the methods described in the embodiments. The storage medium includes any medium that can store program code, such as a USB flash drive, a removable hard disk, a read-only memory (ROM), a random access memory (RAM), a magnetic disk, or an optical disc.

1. A method, wherein the method is applied to an apparatus, and the method comprises:
receiving, first control information in a first time period based on a mapping relationship, wherein the mapping relationship comprises a first mapping relationship between a first parameter set and a first time period, the first parameter set comprises a first parameter.

2. The method according to claim 1, wherein the first parameter set is associated with a first beam.

3. The method according to claim 1, wherein the mapping relationship further comprises a second mapping relationship between a second parameter set and a second time period, the second parameter set comprises a second parameter, and the first parameter is different from the second parameter.

4. The method according to claim 1, wherein the first parameter comprises at least one of control resource set configuration information, a radio network temporary identifier (RNTI), reference signal configuration information, and a control information transmission mode.

5. The method according to claim 4, wherein the control resource set configuration information indicates a time-frequency position corresponding to the first control information, the radio network temporary identifier is used to parse the first control information, the reference signal configuration information indicates a time-frequency position and/or a sequence corresponding to a reference signal, and the control information transmission mode indicates a transmission mode of the first control information.

6. The method according to claim 1, wherein the first time period comprises any one of:
one or more time domain symbols,
one or more slots,
and
one or more subframes.

7. The method according to claim 5, wherein the control information transmission mode comprises a first control information transmission mode, the first control information transmission mode indicates that the first control information comprises a plurality of pieces of control subinformation, and the plurality of pieces of control subinformation respectively correspond to a plurality of terminals.

8. The method according to claim 5, wherein the control information transmission mode comprises a second control information transmission mode, and the second control information transmission mode indicates that the first control information corresponds to one terminal.

9. The method according to claim 6, wherein the control information transmission mode further comprises a second control information transmission mode, and the second control information transmission mode indicates that the first control information corresponds to one terminal.

10. The method according to claim 5, wherein the control resource set configuration information is associated with at least one of the RNTI, the reference signal configuration information, and the control information transmission mode.

11. The method according to claim 7, wherein a position of target control subinformation in the plurality of pieces of control subinformation in the first control information is associated with the first parameter.

12. The method according to claim 1, wherein the first time period is associated with a first time periodicity and a first time offset; or
the first time period is associated with a first time start position and a first time length.

13. The method according to claim 11, wherein the mapping relationship is associated with the time periodicity, the time offset, and a change interval; or
the mapping relationship is associated with the time start position, the time length, and a change interval.

14. The method according to claim 1, further comprising:
performing channel estimation on the first control information in the first time period based on the first mapping relationship, wherein a resource granularity of the channel estimation is N₁ control channel elements (CCEs) or N₂ preset quantity of resource element groups (REGs), and N₁ and N₂ are integers greater than 0.

15. The method according to claim 14, further comprising:
obtaining configuration information, wherein the configuration information indicates the mapping relationship.

16. The method according to claim 4, wherein the control resource set configuration information is used to configure a control resource set, the RNTI identifies a terminal device, the reference signal configuration information is used to configure a reference signal, and the control information transmission mode indicates a transmission mode of the control information.

17. The method according to claim 4, wherein the control information transmission mode comprises group control information transmission and single control information transmission.

18. The method according to claim 1, further comprising:
receiving indication information, wherein the indication information indicates the resource granularity.

19. The method according to claim 13, wherein the change interval is associated with a motion speed of the apparatus.

20. An apparatus, comprising:
a processor and a transceiver interface, wherein:
the transceiver interface is configured to receive first control information in a first time period based on a mapping relationship, wherein the mapping relationship comprises a first mapping relationship between a first parameter set and a first time period, the first parameter set comprises a first parameter; and
the processor is configured to process the first control information.
